(19) United States
(12) Patent Application Publication
(10) Pub. No.: US 2024/0370821 A1
(43) Pub. Date: Nov. 7, 2024

(54) MULTI-FUNCTIONAL DIGITAL INVENTORY MANAGEMENT SYSTEM AND METHOD OF USE

(71) Applicant: Outsetstyle Corp., Chicago, IL (US)

(72) Inventor: Molly Montgomery, Middletown, DE (US)

(21) Appl. No.: 18/633,106

(22) Filed: Apr. 11, 2024

Related U.S. Application Data
(60) Provisional application No. 63/495,456, filed on Apr. 11, 2023.

(51) Int. Cl. G06Q 10/087; G06F 16/951

(52) U.S. Cl. CPC G06Q 10/087; G06F 16/951

(57) ABSTRACT

Disclosed herein are various systems, servers, and computer-implemented method for providing digital inventory management. In an example, the method includes capturing transaction information for a purchase of an item associated with a user; aggregating item information from multiple sources, wherein at least one of the multiple sources is accessed using a connection through an API. The method includes normalizing the captured transaction information and the aggregated item information. Additionally, the method includes enriching the transaction information or the item information by obtaining additional information associated with the item or the transaction from multiple different sources. The method also includes generating a digital inventory based on the enriched data, wherein the digital inventory includes a listing of the item based on the enriched data. Additionally, the method includes providing a user interface for viewing and managing the digital inventory.

### CROSS-REFERENCE TO RELATED APPLICATION

The present application claims priority to U.S. Provisional Patent Application No. 63/495,456, filed Apr. 11, 2023, the disclosure of which is considered part of and is incorporated by reference into this patent application.

### TECHNICAL FIELD

The present disclosure relates generally to inventory management and, more specifically, to a multi-functional digital inventory management and third-party reseller cross-listing system and method of use.

### BACKGROUND

Traditionally, when a user makes a purchase, whether online or in-store, the user receives a receipt confirming the transaction between the user and the retailer, and it may be provided to the user in digital form, physical form, or both. The retailer, credit card companies, or banks may generate transaction details in the receipt. Retailers, credit card companies, and banks all provide different information surrounding the product transaction, with banks and credit card companies providing the most limited information on the product details in their statements.

Product details, however, may not be included in the receipt. There may be missing details related to purchasing and product details when a transaction takes place. Missing details may include photos, product titles, product descriptions, color, category, subcategory, SKU numbers, product care, sizing, or other missing details. Receipts are often the only informational record provided to users after a purchase summarizing the transaction. Receipts are limited in detail on the product, so users often lack important information about the product and other purchasing details that took place in the transaction. In addition to the difficulty or inability to obtain some types of purchasing and product data, the data obtained by users often cannot be easily transformed into a format that allows the user to manage their inventory in a unified way and a single place.

Furthermore, data on the inventory item, which could come from retailer web pages, is removed once the retailer is no longer selling the item. Thus, it is erased from the web. As a result, the consumer cannot reference the product details after a limited time frame (typically days or months but maybe years, depending on the types of inventory). There is no centralized system that catalogs historical e-commerce inventory listings from the web or a system that references historical listings in a standardized process, as no repository exists. As a result, consumers lack management capabilities on the possessions they purchase. Management capabilities could include a standardized way to view, access data, plan, value, or connect their possessions to 3rd party sites through automated processes that do not require the consumer to manually catalog their possessions purchases made from multiple retailers. These services do not exist today but need to be in place as they may allow consumers to value their possessions and make better-informed buying, managing, and reselling decisions. Additionally, it would allow the consumer to enhance the utility of their existing possessions and understand the value of their possessions.

Accordingly, a need exists for a non-intrusive mechanism that automatically tracks consumer purchases, aggregates detailed information from multiple web and database sources, and transforms and standardizes their data into a personalized digital possession portfolio that can be used for multiple new purposes. As mentioned before, this is not possible today as data on consumers' possessions purchases is not tracked in a unified or centralized location, and details on product web pages are no longer referenceable after a certain period.

Existing solutions do not provide consumers access to a platform that automatically aggregates details on their possessions purchased across multiple retailers in one place in real-time or close to real-time after purchase. Today, consumers must manually create a digital listing of their possession items and typically do so to resell, upload to a wardrobe app or styling app, or the like. To resell on sites like eBay or other legacy resale sites, the consumer must create an item listing by manually filling out a form (typically 15-25 questions long) on the product's title, description, brand, retailer, purchased price, purchased size, listing price, category, subcategory, style tags, quantity, color, photos, and more. This can be very tedious for the consumer.

Today, cross-listing platforms such as Vendoo, OneShop, and List Perfectly allow users to list inventory from a centralized location onto sites like eBay and other marketplaces. Cross-listing platforms require users to manually catalog their items before selling. Legacy resale sites' selling forms (a.k.a listing forms) vary in length, questions, and answer types.

AI image technology exists today that can add descriptors based on obvious physical elements. For example, a dress purchased on a fashion website named Revolve is called the “Jade Mini Dress in Plum Pinstripe” (FIG. 25). The colors plum pinstripe and the title of the garment reflect the unique naming conventions in women's fashion inventory that create friction in eCommerce and resale. Image technology could identify obvious physical identifiers (dress in purple), but it won't be able to identify the assigned title and color (pinstripe plum). On resale marketplaces, buyers frequently search for the keywords, which creates supply and demand issues as sellers often can't find the original identifiers. Some imaging technologies integrate Internet search algorithms, such as Google Lens. This technology uses imaging to search for information that currently exists online. However, as previously mentioned, e-commerce inventory listings are erased from the internet after the retailer removes them, and there is no place to reference historical e-commerce listings. A situation could exist where the inventory item is uploaded on a third-party site, such as a legacy resale platform. Still, these listings are subject to human error and have a high likely hood of not containing accurate, original details. Finally, neither technology can automatically identify the transaction details specific to the user, including the price paid, purchase date, retailer purchased from (multiple retailers are common for women's fashion inventory), years owned, size purchased, or other details. Image technology does not provide a solution for possession management or bring accuracy to resale, as details may not be accounted for by image technology alone. Without continuous data collection and archiving, the temporary nature of many online product listings and other data may produce incomplete digital listings that cannot be remedied later.

Millions of today's consumers have an inventory management problem because they have lost track of the possessions in their homes that have built up through the years.

### SUMMARY

The present disclosure relates to digital inventory management systems and methods that streamline managing personal or business assets. These systems and methods provide an integrated solution for capturing transaction information, aggregating item details from multiple sources, normalizing and enriching data, and generating a comprehensive digital inventory. This digital inventory includes listings of items based on enriched data, which can be viewed and managed through a user-friendly interface. Additionally, the systems offer features such as automated valuation of individual listings or the entire collection of possessions. The disclosed embodiments include computer-implemented methods, servers, cloud-based systems, and Software as a Service (SaaS) platforms, all designed to transform and assemble data from third-party web pages into customized digital inventory listings for multipurpose use.

An example embodiment includes a computer-implemented method for providing digital inventory management. The method includes capturing transaction information for a purchase of an item associated with a user. The method includes aggregating item information from multiple sources, wherein at least one of the multiple sources may be accessed using a connection through an API. The method includes normalizing the captured transaction information and the aggregated item information. The method also includes enriching the transaction or item information by obtaining additional information from multiple sources associated with the item or the transaction. Additionally, the method generates a digital inventory based on the enriched data, wherein the digital inventory includes a listing of the item based on the enriched data. The method includes providing a user interface for viewing and managing the digital inventory.

An example embodiment includes a server, a memory, a database, and a processor. The processor may be configured to capture transaction information for purchasing an item associated with a user. The processor may also be configured to aggregate item information from multiple sources, wherein at least one of the multiple sources may be accessed using a connection through an API. The processor may be configured to normalize the captured transaction information and the aggregated item information. Additionally, the processor may be configured to enrich the transaction or item information by obtaining additional information associated with the item or the transaction. The processor may be configured to generate a digital inventory based on the enriched data, wherein the digital inventory includes a listing of the item based on the enriched data. The processor may also be configured to provide a user interface for viewing and managing the digital inventory.

An example embodiment includes a system including a back-end server implemented within a cloud-based computing environment. The back-end server may be configured to capture transaction information to purchase an item associated with a user. The backend server may also be configured to aggregate item information from multiple sources, wherein at least one of the multiple sources is accessed using a connection through an API. The backend server may also be configured to normalize the captured transaction and aggregated item information. The back-end server is configured to enrich the transaction or item information by obtaining additional information associated with the item or the transaction. Additionally, the back-end server is configured to generate a digital inventory based on the enriched data, which includes a listing of items based on the enriched data. The backend server may also be configured to provide a user interface for viewing and managing the digital inventory.

An example embodiment includes a system for providing digital inventory management via Software as a service (SaaS). The system includes a computer communicatively coupled to a network, at least one SaaS provider, and at least one SaaS user. The computer is configured to capture transaction information for purchasing an item associated with a user. Additionally, the computer is configured to aggregate item information from multiple sources, wherein at least one of the multiple sources is accessed using a connection through an API. Additionally, the computer is configured to normalize the captured and aggregated transaction information. The computer may also be configured to enrich the transaction or item information by obtaining additional information associated with the item or the transaction. Additionally, the computer is configured to generate a digital inventory based on the enriched data, wherein the digital inventory includes a listing of the item based on the enriched data. The computer may also be configured to provide a user interface for viewing and managing the digital inventory.

An example embodiment includes a computer-implemented method comprising instructions stored on a non-transitory computer-readable storage medium and executed on a computing device with a hardware processor and memory for providing digital inventory management via Software as a Service (SaaS). The method including capturing transaction information for a purchase of an item associated with a user. The method including aggregating item information from multiple sources, wherein at least one of the multiple sources is accessed using a connection through an API. The method also normalizes the captured transaction and aggregated item information. Additionally, the method includes enriching the transaction or item information by obtaining additional information associated with the item or the transaction. The method also generates a digital inventory based on the enriched data, wherein the digital inventory includes a listing of the item based on the enriched data. The method includes providing a user interface for viewing and managing the digital inventory.

An example embodiment includes a computing system configured to transform and assemble data from third-party web pages across multiple websites into customized digital inventory listings for multi-purpose use. The computing system includes browser software installed on a user's device, configured to recognize a user's purchasing activity on the browser. Based on the user's purchasing activity, the browser software automatically captures specific product and purchasing details from multiple web-based sources. The browser software may also be configured to store the specific product and purchasing details in a system database, wherein the system database is configured to receive and assemble the specific product and purchasing details from multiple web-based sources into a single digital inventory listing, wherein the single digital inventory listing is customized for the user catalog the single digital inventory listing including presenting the single digital inventory listing to the user via a graphical user interface, and alter the graphical interface based on receiving user input or new purchase activity. The browser software is configured to invoke a function of use on a third-party website to automatically cross-list a product from the single digital inventory listing based on the specific product and purchasing details from multiple web-based sources and user-provided information.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary and the following detailed description are better understood when read in conjunction with the accompanying drawings. The accompanying drawings, which are incorporated herein and form part of the specification, illustrate a plurality of embodiments and, together with the description, further explain the principles involved and enable a person skilled in the relevant art(s) to make and use the disclosed technologies.

FIG. 1 depicts an exemplary process flow for providing and managing a digital personal possession portfolio management system according to an embodiment of the subject matter described herein.

FIG. 2 depicts a system for providing and managing a personal digital possession management system according to an embodiment of the subject matter described herein.

FIG. 3 depicts further details of a back-end server for providing and managing a digital personal possession portfolio according to an embodiment of the subject matter described herein.

FIG. 4 depicts further details of a computing device for accessing, viewing, and managing a digital personal possession portfolio according to an embodiment of the subject matter described herein.

FIG. 5 illustrates an exemplary software-as-a-service (SaaS) model for providing and managing a digital personal possession portfolio management system according to an embodiment of the subject matter described herein.

FIG. 6 depicts screenshots of an exemplary user interface for creating a user account and updating user information associated with a digital personal possession portfolio according to an embodiment of the subject matter described herein.

FIG. 7 depicts a screenshot of an exemplary user interface for prompting the user to import purchase history data associated with a digital personal possession portfolio according to an embodiment of the subject matter described herein.

FIG. 8 depicts a screenshot of an exemplary digital personal possession portfolio user interface while data may be actively being collected according to an embodiment of the subject matter described herein.

FIG. 9 depicts a screenshot of an exemplary user interface of a user's email account showing an electronic receipt of a purchased item managed by the digital personal possession portfolio according to an embodiment of the subject matter described herein.

FIG. 10 depicts a screenshot of an exemplary user interface on a third-party website of a product or item to be imported and managed with the digital personal possession portfolio according to an embodiment of the subject matter described herein.

FIG. 11 depicts a screenshot of an exemplary user interface for user approval of digital listings for items in the personal digital possession portfolio according to an embodiment of the subject matter described herein.

FIG. 12 depicts a captured image of a physical receipt of a purchased item that can be uploaded and managed within the digital personal possession portfolio according to an embodiment of the subject matter described herein.

FIG. 13 depicts a screenshot of an exemplary user interface of browser software for prompting users to sync purchase data with their digital personal possession portfolio according to an embodiment of the subject matter described herein.

FIG. 14 depicts a screenshot of an exemplary digital personal possession portfolio user interface according to an embodiment of the subject matter described herein.

FIG. 15 depicts a screenshot of an exemplary digital personal possession portfolio user interface according to an embodiment of the subject matter described herein.

FIG. 16 depicts a screenshot of an exemplary digital personal possession portfolio user interface according to an embodiment of the subject matter described herein.

FIG. 17 depicts a screenshot of an exemplary user interface for manually uploading an item to the user's digital personal possession portfolio according to an embodiment of the subject matter described herein.

FIG. 18 depicts a screenshot of a cross-listing form to a legacy resale platform that is automatically updated using the data pulled at the point of purchase from multiple web pages.

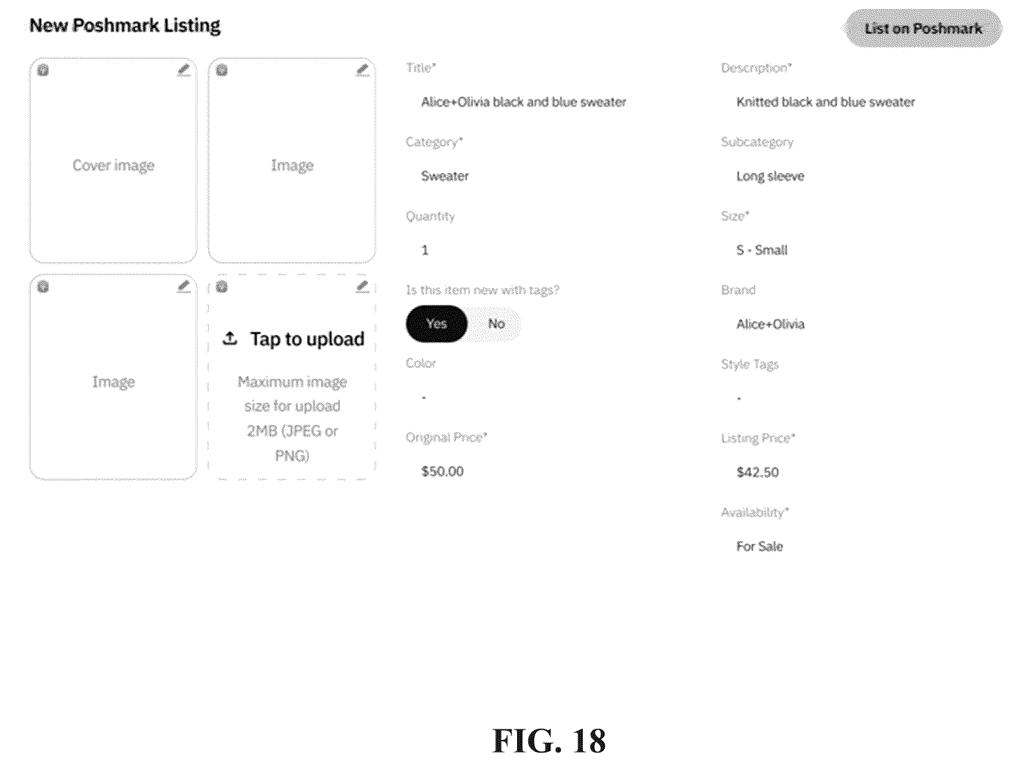

FIG. 19 depicts a screenshot of a user experience cross-listing multiple inventory items at one time.

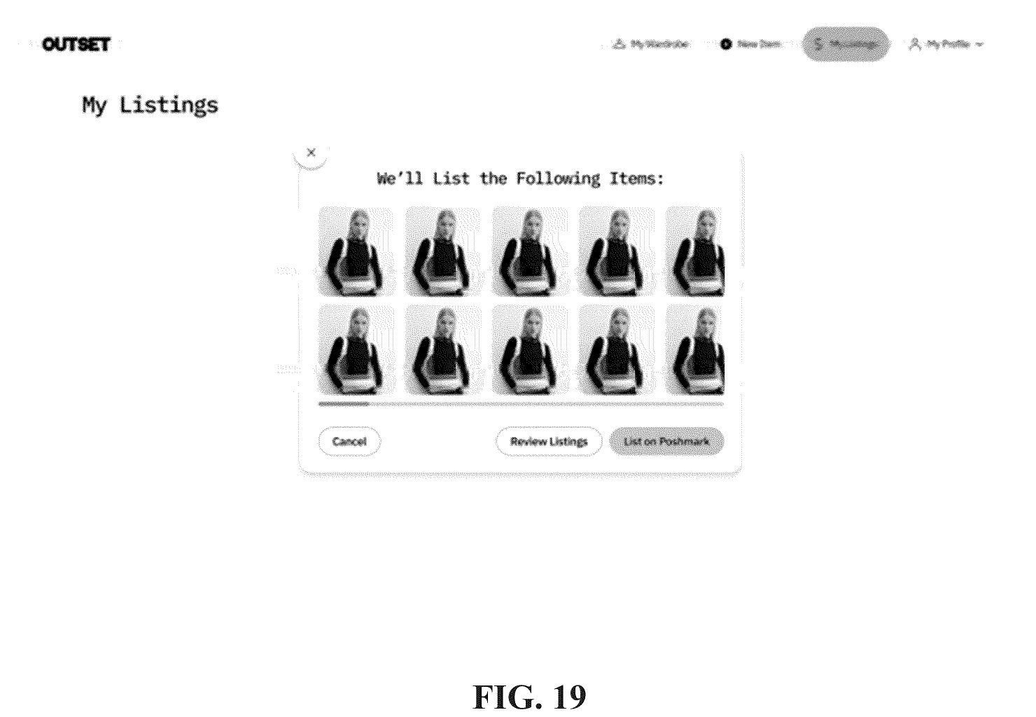

FIG. 20 is a screenshot of the main clothing categories on Bloomingdales.com, and Revolve.com is an example of how retailers use different types of categories and different names for the same category.

FIG. 21 is a screenshot of eBay's online selling form for uploading an inventory item.

FIG. 22 is Shopbop.com's, a US fashion retailer, “9-5” workwear page. These are products that Shopbop.com has identified as workwear outfits for shoppers.

FIG. 23 is an example of the defined categories and a list of some subcategories that provide organization across wide sets of data pulled from numerous webpages.

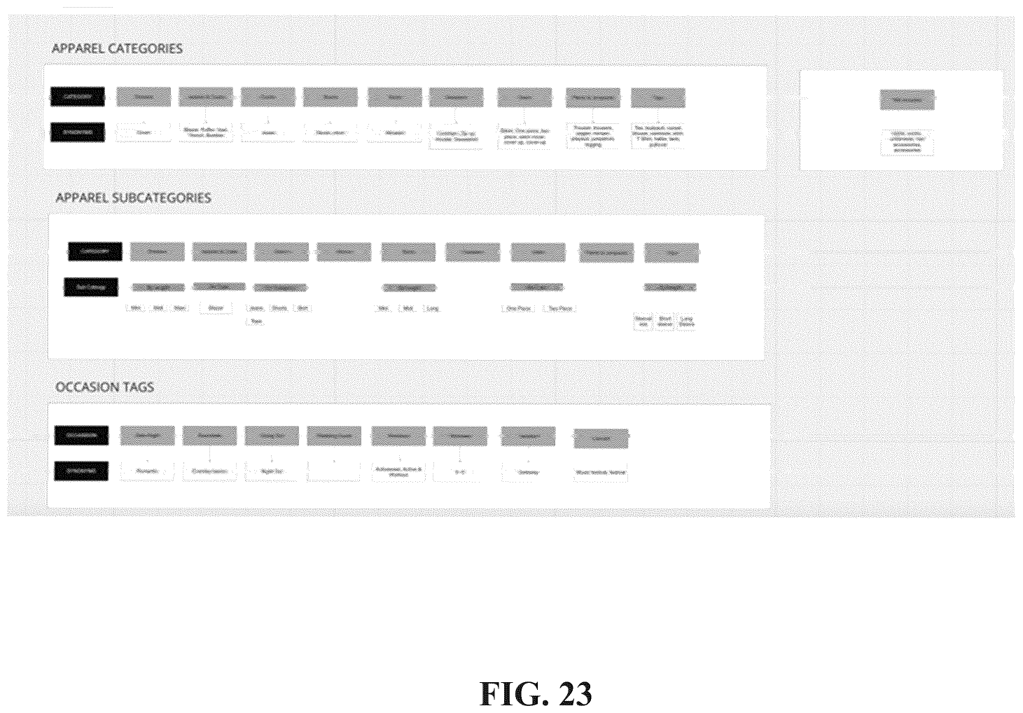

FIG. 24 allows users to sync their accounts with 3rd party resale sites such as eBay.

FIG. 25 is an email receipt from Revolve.com, a US fashion retailer, in a Gmail inbox.

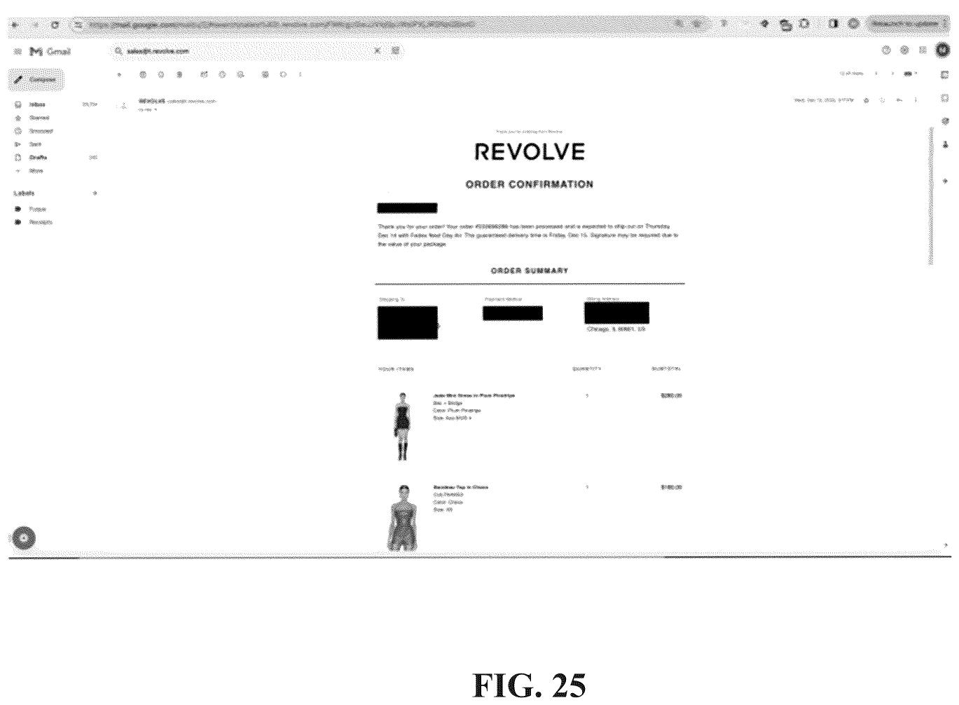

FIG. 26 is Revolve.com, a US fashion retailer, and illustrates that under the category “Jackets & Coats,” there are specific style tags, including the tag “Balzer.”

FIG. 27 is OneShop's, a cross-listing platform, form to upload inventory manually.

FIG. 28 is OneShop's, a cross-listing platform that includes differing questions requiring separate answers for each marketplace.

The figures and the following description describe certain embodiments by illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable, similar or similar reference numbers may be used in the figures to indicate similar or similar functionality.

### DETAILED DESCRIPTION

The detailed description set forth below in connection with the appended drawings is intended as a description of configurations. It is not intended to represent the only configurations in which the concepts described herein may be practiced. The detailed description includes specific details to provide a thorough understanding of various concepts. However, it will be apparent to those skilled in the art that these concepts may be practiced without these specific details. In some instances, well-known structures and components are illustrated in block diagram form to avoid obscuring such concepts.

Embodiments of the systems, methods, and devices described herein may have one or more of the following capabilities. For example, one embodiment of the systems, methods, and devices described herein may include a multi-functional digital inventory management system, and methods of use are disclosed. A computing system may be configured to transform and assemble data from third-party web pages across multiple website(s) into customized digital inventory listings for multipurpose use. Browser software installed on a user's device recognizes the user's purchasing activity. Based on the user's purchasing activity, it automatically captures specific product and purchasing details from multiple web-based sources. The specific product and purchasing details are stored in a database that receives and assembles the specific product and purchasing details from multiple web-based sources into a single digital inventory listing customized for the user. The computing system invokes new functions. New Functions include valuation data so the user can see an estimated value of their portfolio of possessions and on third-party websites, including automatically cross-listing a product from the single digital inventory listing, based on the product and purchasing details and user-provided information, across one or more reseller sites.

The disclosed subject matter is directed to systems and methods for automatically tracking consumer purchases, aggregating detailed information from multiple web and database sources, and transforming the data into a personalized digital inventory listing that can be used for multiple new purposes. The systems and methods described herein receive or intercept purchasing and other data from various software services and digital sources, analyze and enhance that data to provide a comprehensive and unified digital presentation of a user's physical inventory, and provide tools for new uses of the inventory and leveraging the possession data. For example, the systems and methods described herein may automatically create a customized digital inventory listing that may be listed for sale on one or more external, third-party websites (e.g., cross-listed) in a new digital format that conforms to the external websites' listing constraints, where the item listed for sale on the external websites includes clothing. The listing uses information gathered and stored in the personal digital possession portfolio (or digital possession management platform) described herein.

The systems and methods described herein thus provide for interfacing with web pages across multiple websites to realize and transform data into personalized, digital inventory listings that carry out multifunctional use both on the internal platform and various third-party websites and databases. In one embodiment, a user's purchase automatically triggers the browser software interfacing with web pages across multiple website(s) to transmit realized data to the server database. The server database assembles the data into customized digital inventory listings with altered graphics and new functionalities, which can be used internally or automatically for new purposes or transmitted to external third-party websites and databases for various use cases.

The system and methods herein provide a system and method that aggregates and standardizes data. A data model and logic map various values from thousands of brands and retailers into a standard catalog of defined categories. All the products extracted from the receipts and webpages of different retailers are stored in this unified data model.

The systems and methods described herein provide a practical application in that they automatically generate new data from a purchase transaction and automatically connect to third-party websites (e.g., a resale site via an API) to trigger functionality on the third party.

The systems and methods described herein provide a system that creates a new resale listing on a third-party site, all with minimal or no user interaction. This provides cross-listing efficiency, allowing the user to manage online postings easily and quickly without additional input. This further allows for more complete and standardized listing details on the third-party reseller websites, including additional information about the item being sold or the original purchase of the item that the user does not possess. In this way, the user avoids searching for and finding additional information that may not otherwise exist. It also benefits shoppers who can find the item with accurate data.

The systems and methods described herein provide a wide-ranging practical application of digital inventory listings that generate a digital portfolio of one's possessions. Methods of use include users accessing automated resale value estimation for the digital listings. This resale value may be calculated using multiple sources, including various web pages, purchasing and product data, and internal information collected on the platform. Today's consumers cannot efficiently understand the real-time value of their possessions. The value of the possession may be created by identifying purchasing details from multiple web pages and internal purchasing details. A solution for consumers to verify the value of their fashion possessions does not exist. This often leads to missed selling opportunities and items becoming sunk costs. This may be especially true for women's fashion items subject to short-cycle fashion trends.

The platform interface aggregates personalized data on one's possessions in real-time or near real-time, allowing users to have clear visibility in one organized inventory management platform. The data and insights page provides viewing capabilities and insights into their possessions they otherwise would not have. Examples of analytics and graphs include total investment on possessions in their closet (handbags, apparel, and shoes), spending by category, color analysis by products and categories, spending by color, number of inventory items by categories, number of items by attributes such as color, pattern, style, season, and the like. Other data points include top retailers, brands, and categories by inventory number and by spend, frequency of purchases, and more. These data points help the consumer understand their purchasing habits. Other data and insights might be pulled from sources such as their phone camera roll. The platform can drive further insights into likability and utilization (wear frequency) by allowing access to photos. For example, the platform could automatically track the wear of garments without the user manually inputting this data. The consumer has unique viewing and filtering capabilities for all other possessions, including category, color, price, oldest to most recent purchase, retailer, brand, and all other possessions. The data and insights page and the inventory page are created automatically without any work from the consumer. Additional management capabilities exist on the platform, including planning. For example, the user may interact with the possessions to plan outfits, rank items, dislike items, and other possessions.

A real-time possession portfolio management platform helps the user understand the value of their items. It helps users make better-informed buying decisions (for example, avoiding repeat purchases) and resale decisions (for example, having a reminder to sell garments after a certain period.) By analyzing multiple web pages, and purchasing data, including date of purchase utilization (which may include data automatically pulled from the camera roll), the user will better understand their item's value, allowing them to make a better decision to resell.

The subject matter disclosed herein includes aggregating data from multiple resources after a user purchases an item online or in-store and transforming or enriching the aggregated data into a new, personal, digital listing. One or more digital listings may be stored in a “Personal Possession Portfolio,” where each digital listing (singular) in the Personal Possession Portfolio may be referred to as a “Digital Possession Inventory Listing” (or “Digital Inventory Listing” for short). Thus, all the digital inventory listings comprise the “Personal Possession Portfolio.” Digital inventory listings are created for multiple purposes, including automatic transformation from a “Digital Possession Inventory Listing” to a listing on a third-party platform. This could include listings on marketplaces for resale that accept and promote cross-listing platforms such as eBay, a first-party marketplace platform, or another third-party site. Another additional use could be informing the user of the estimated resale value.

A computing system is disclosed herein that interfaces with third-party web pages across multiple website(s) and obtains a user's purchasing information, which may then be assembled and transformed into one or more customized digital inventory listings. The digital inventory listings can then be used for multiple purposes, including automatically generating and posting new listings on various websites in the correct digital format for each of the various websites or informing the user about the value of their possession.

The computing system described herein aggregates captured data with user-specific data aggregated from one or more third-party websites, alters and/or creates new graphics, and invokes new functions of use on other third-party websites and databases. Data maybe captured through a multifaceted approach depending on user settings.

In one embodiment, browser software installed on a user's computing device may intercept, retrieve, receive, or otherwise capture information associated with a user's purchases. Thus, the online computer system may include a system database, browser software installed on a user device, and a display, wherein the system database and the user's computing device are connected to a network. The browser software may be configured to recognize consumer purchasing activity, which triggers the software to automatically capture the user's specific product and purchasing details from multiple web pages across multiple website sources. The browser software may then automatically transmit the data to the system database.

In another embodiment, upon signup, the users' email account and database are paired, and a connection between the inbox and system database may be maintained. Updates in the inbox trigger the system database to extract purchasing details and trigger the software to pull additional data from multiple web pages and websites done in real-time or closet to real-time.

In another embodiment, data can be manually uploaded to the server database. For example, when the user provides a personal account, the user may enter details about a particular item purchased. It is appreciated that information entered manually by the user is often not otherwise obtainable by request from third-party databases or websites and, as such, provides additional value when combined with the data obtained from third-party databases or websites.

The functionality for automatically tracking consumer purchases, aggregating detailed information from multiple web and database sources, and transforming the data into a personalized digital inventory listing that can be used for multiple new purposes disclosed herein may be generated by email pairing or browser software (e.g., a browser extension) that may be authored for a particular web browser. The browser software may be a plug-in (i.e., a software component that adds a specific feature to an existing computer program) that extends the web browser's functionality. For example, the browser software, according to an embodiment described herein, modifies the user interface when a user purchases or browses an online item by displaying a prompt (e.g., a pop-up notification or window), allowing the user to export data and metadata associated with that online item from the website displaying the online item to the user's Digital Personal Possession Portfolio.

The following description and figures are illustrative and should not be construed as limiting. Numerous specific details are described to provide a thorough understanding of the disclosure. In certain instances, however, well-known or conventional details are not described to avoid obscuring the description. References to “one embodiment” or “an embodiment” in the present disclosure may be (but are not necessarily) references to the same embodiment, and such references mean at least one of the embodiments.

In this specification, reference to “one embodiment” or “an embodiment” means that a particular feature, structure, or characteristic described in connection with the embodiment is included in at least one embodiment of the disclosure. Multiple appearances of “in one embodiment” in various places in the specification do not necessarily refer to the same embodiment, nor are separate or alternative embodiments mutually exclusive of other embodiments. Moreover, various features are described, which may be exhibited by some embodiments and not by others. Similarly, various requirements are described, which may be requirements for some embodiments but not for other embodiments.

The terms used in this specification generally have their ordinary meanings in the art, within the context of the disclosure, and in the specific context where each term is used. Certain terms used to describe the disclosure are discussed below or elsewhere in the specification to provide additional guidance to the practitioner regarding the disclosure description. For convenience, certain terms may be highlighted, for example, using italics and/or quotation marks. The use of highlighting does not influence the scope and meaning of a term; the scope and meaning of a term are the same in the same context, whether or not it is highlighted. It would be appreciated if the same could be said in multiple ways.

Consequently, alternative language and synonyms may be used for any one or more of the terms discussed herein, nor is any special significance to be placed upon whether or not a term is elaborated or discussed herein. Synonyms for certain terms may be provided. A recital of one or more synonyms does not exclude using other synonyms. The use of examples anywhere in this specification, including examples of any terms discussed herein, is illustrative only and is not intended to limit further the scope and meaning of the disclosure or any exemplified term. Likewise, the disclosure is not limited to various embodiments in this specification.

Without intent to limit the scope of the disclosure, examples of instruments, apparatuses, methods, and their related results according to the embodiments of the present disclosure are given below. Note that titles or subtitles may be used in the examples for the convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Currently, methods and systems for inputting digital inventory listings are almost the same as in the 1990s when eBay began its resale marketplace. For example, conventional technologies do not scan receipts or purchase data to populate digital listings that can be transformed for new purposes on third-party sites; this could include styling or reselling. Instead, conventional solutions involving services related to personal possessions use a manual upload form within the application, requiring the user to manually fill out the application details.

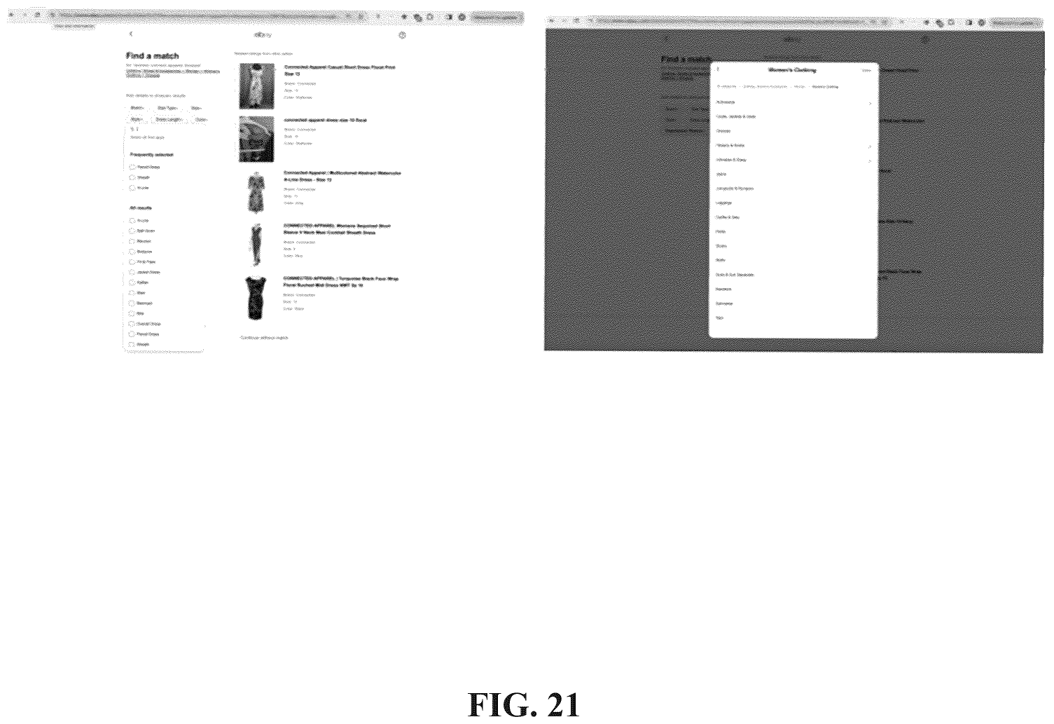

In addition to the limitations of manual data entry associated with buying new clothing, conventional methods and systems also require manual data entry when selling used clothing (FIG. 21). As a result, a user wishing to input purchase information and product details to manage their inventory (e.g., cross-list a previously purchased item for resale) may be multi-faceted and time-consuming. For example, the process typically involves researching past purchases, manually filling out and submitting various forms, and uploading a unique combination of information for each third-party website on which the user wishes to market their inventory listing. Current resale applications or services, such as eBay®, typically require the user to fill out a manual “listing form” including 15-25 questions for providing product-specific details, such as the category, brand, size, color, description, price paid, and other similar elements. When clothing may be purchased and sold, this manual data entry burdens a user managing a large and/or constantly evolving wardrobe or personal inventory of possessions. Additionally, a complete digital inventory listing as described herein often requires additional data points that do not currently exist in one location, which may be why the presently disclosed subject matter creates one or more additional data points using purchasing data, product information, checkout details, and internal information obtained from server database(s) and/or third-party websites.

As a result of this manual data collection and inventory management process, which also lacks proof of sourcing and purchasing verification, almost all major resale e-commerce platforms include incorrect or outdated information in their listings or generic data reflecting obvious physical details but not consistent with any original identifiers at point of purchase. Resale sites are subject to high amounts of human error. Additionally, it may be appreciated that data collection may be impossible because the data may no longer be available online after some time (for example, weeks or months). In other words, without continuous data collection and archiving, the temporary nature of many online product listings and other data may produce incomplete digital listings that cannot be remedied later. These friction points often deter users from understanding the value and inventory of the possessions they buy, which may limit or deter them from partaking in selling inventory on resale platforms. Other negative user experiences may be exacerbated for users susceptible to scams, inaccurate listings, or fraudulent listings.

While resale platform processes have remained the same, user purchasing habits have evolved. For example, the purchase rate of users has significantly increased over the years. As more users purchase more items more often and have a larger and larger inventory of items to be managed, the problems associated with current systems only become greater. A Digital Possession Portfolio allows for inventory management, an understanding of the resale value, and the automated transformation into new methods of use on third-party sites.

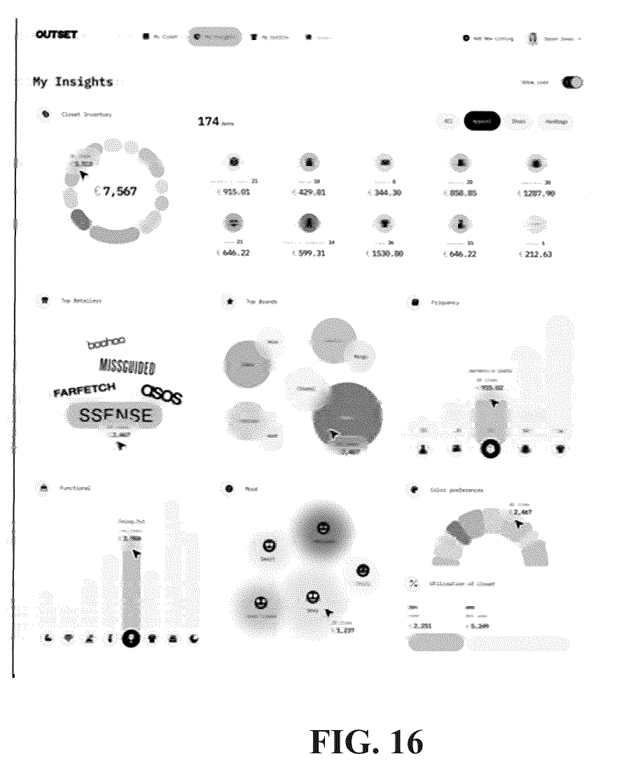

In contrast to these conventional methods and systems, some embodiments described herein may automatically populate informative data points such as a user's top brands, top retailers, number of possessions, number of possessions by category, color breakdown of possessions, and other similar elements. For example, the platform may show a breakdown of the colors purchased relating to all the possessions and how much was spent on possessions in that color (FIG. 16). The platform aggregates a user's data. It provides information on individual possessions and the total portfolio of possessions that they would not know and be unable to do manually. Currently, there is no way to automatically track inventory in one place, nor can automated data and analytics on possessions be accessed (this includes estimations on the real-time value). Some embodiments may capture real-time data of possessions such as a user's clothing differentiates it over previous systems that do not provide SKU level details organized in a unified format for products purchased cross-retailer.

In an example embodiment, managing capabilities may include automated valuation of individual listings or the entirety of the possessions.

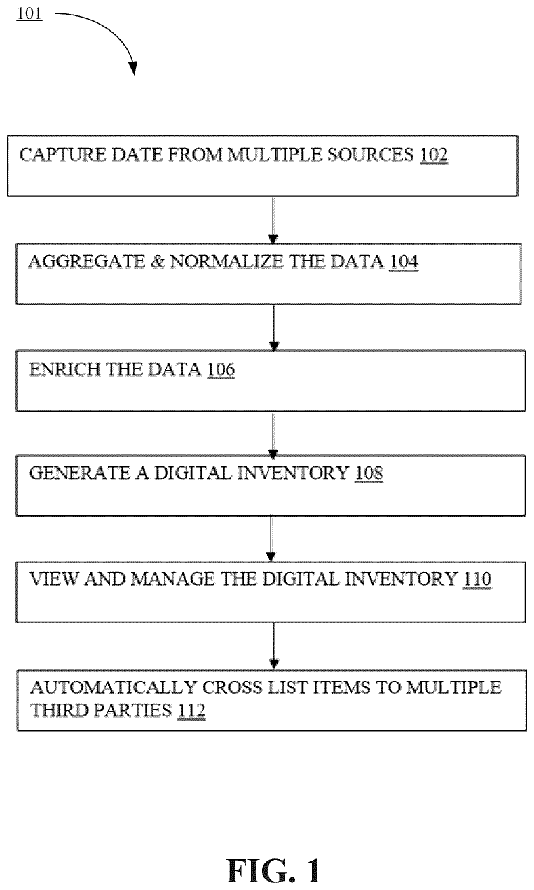

FIG. 1 depicts an exemplary process flow for managing a Digital Personal Possession Portfolio according to an embodiment of the subject matter described herein. Referring to FIG. 1, the method includes, at step 102, capturing data from one or more sources. One or more sources may include the user's email account where receipts or other purchase details/confirmations for purchases are sent, online retailers' websites and/or databases or servers, retailers' point-of-sale (POS) systems, third-party reseller websites and/or databases or servers, manual data entry from the user, and the like. The data may be captured from one or more sources via a connection to the various sources through an application programming interface (API). The data may be captured as raw data objects from various sources.

Initially, the user may create a user account or profile in the system. The user may provide and/or verify user profile information, such as user identity, contact information, login credentials, birthdate, sizing, height, pant size, top size, and bra size, which may be stored as part of a user profile in a database or other memory and used by the system.

The captured data, which may be used for obtaining a complete and accurate inventory of the user's possessions, may be captured historically (e.g., for previous sales and/or products) or in real-time (e.g., captured as new purchases are made). Thus, the captured data may include both historical and real-time (or near real-time) data. Historical and real-time data capture methods are automated and do not require the user to do work, but they can be done manually, depending on user preference. The data may be captured or received in real-time, or the data sources may be polled periodically during a periodic data-gathering process.

In one embodiment, an email scraping or extraction tool may capture the user's historical purchasing data to gather previous purchase information to digitize the user's existing wardrobe. In an exemplary scenario, a user has purchased every item in their possession online. The user has received an email receipt or purchase confirmation for each online purchase, which may be stored in their email inbox. The subject matter described herein includes obtaining or obtaining access to the user's email inbox to scan the email inbox to locate or identify purchase receipts or confirmations and ingest product or purchase data from these email receipts or confirmations. When an email hits the server, an endpoint parses the data and pushes it to a receptor on the server. Information extracted from the receipt may extract include metadata and other enriched data from multiple sources based on the extracted information. It is appreciated that a system default may be defined to capture purchasing data for a predefined period, such as the previous two years. However, this default setting can be customized by the system and/or by the user. The email scraper may further be configured to analyze each new incoming email as it scrapes it for purchase data.

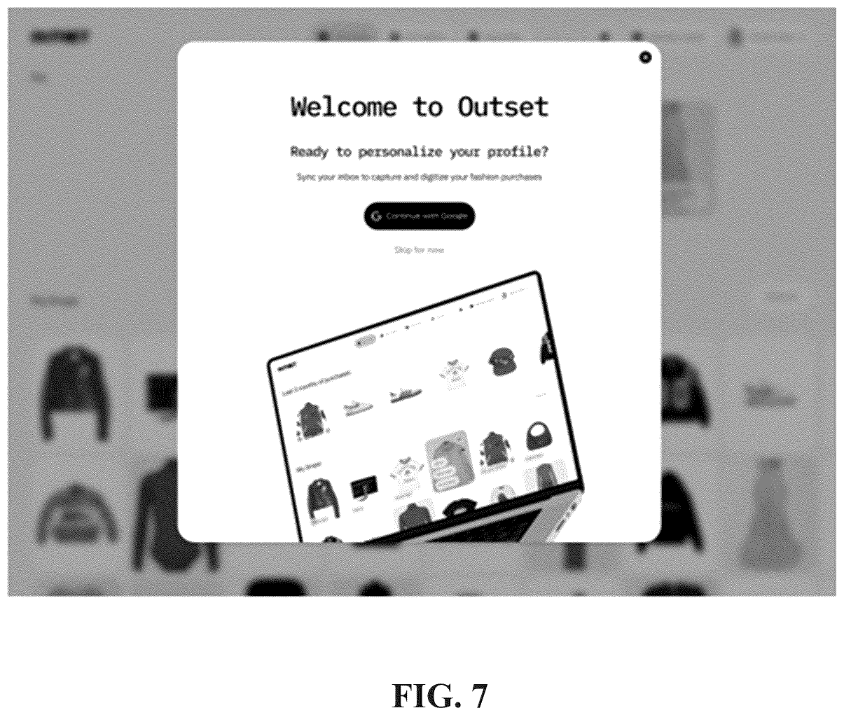

When signing in, in one embodiment, a new user may be prompted: “Ready to Digitize/Personalize Your wardrobe?” (FIG. 7). The user may begin the digitization process by clicking a “sync/go to email” button which pairs their email. The system may then automatically load the user's email login on the screen where the user approves the system's access to their email. Upon providing the login information and approving the system access to the user's email, the system may establish an online connection between the system and the user's email system, for example, using an API call. Once connected, the system may automatically present the user with a user interface. At the same time, an email scraper begins capturing data from email receipts over a predetermined time (e.g., the last two years). While this data collection process may be performed, a loading message may appear on the screen.

In one embodiment, receipts or confirmations are identified based on the “from” address of the email, the domain from which the email may be received, or one or more keywords embedded in the email. The receipts sought for capturing data may be limited to specific item categories such as apparel, shoe, and handbag retailers/brands. It is appreciated, however, that the system may also be configured to capture data on items associated with other categories and industries. In this example embodiment, the email scraper may capture the following information from receipts: brand, retailer, date purchased, size purchased, product name, product picture, retail price, price paid, color purchased, description, order number, item SKU, or other information.

Once purchasing information is identified through the receipt or browser, the metadata on the receipt may include a link to the original Uniform Resource Locator (URL). The URL patterns implemented explore large amounts of retailers and designer web pages to determine navigation paths that lead to the pages where additional tags are located (e.g., styling or occasion pages). This was challenging as URL patterns are different across sites and multiple web pages are searched—merely inspecting the product page may be impossible as additional tags exist elsewhere and are not consolidated in one central location across retailers. Web scrapping scripts are programmed to follow a structural path to look for the key identifiers and then look for subsequent identifiers; thus, including logic to implement conditional logic to handle the variation across retailers' and designers' web pages was necessary.

The method includes, at step 104, aggregating and normalizing the captured data. As explained above, data may be captured from various sources and formats. The captured data from the various sources may be aggregated and normalized. For example, dates and sizes may be standardized or converted to different-size units. The platform has a defined data model to capture different product details, like the name, brand, category, size, color, price, and cover image. There may be logic built to map different retailers' values into the corresponding values in some embodiments' standard catalog of brands and categories. All the products extracted from the receipts of different retailers are stored in this unified data model. This gives the customer unified organizational search, visibility, and product pages of data across hundreds of designers and retailers. The method includes, at step 106, enriching the data. Enriching the data may include adding additional data to the captured data, removing data from the captured data, reformatting the captured data, adding cross-references to other data based on relationship data, or the like. For example, additional data may be added to the captured data, where the additional data may be added by automatically locating the additional information on one or more websites that contain relevant product information such as description, care, additional images, product guides, item SKU, Retailer SKU, and the like. As another example, the user may manually add additional data.

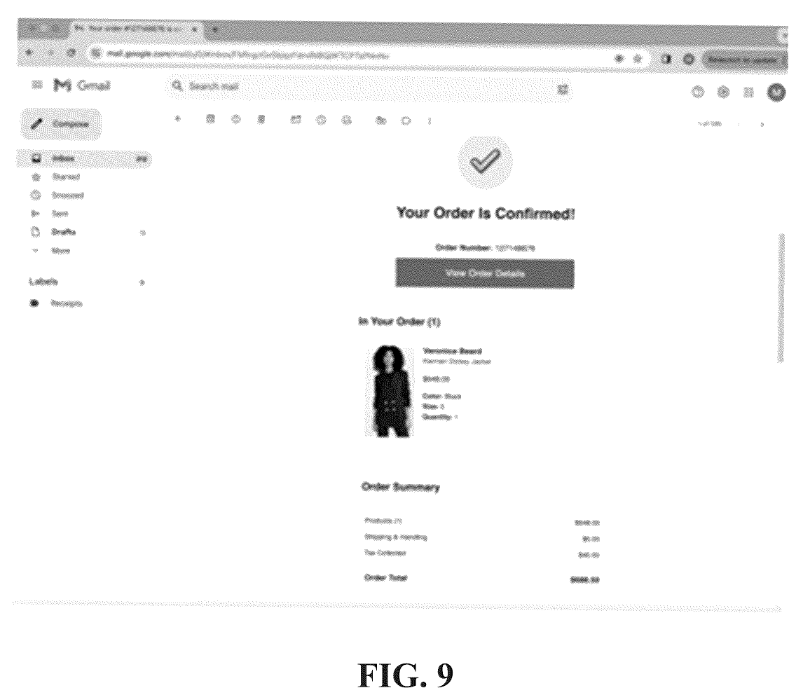

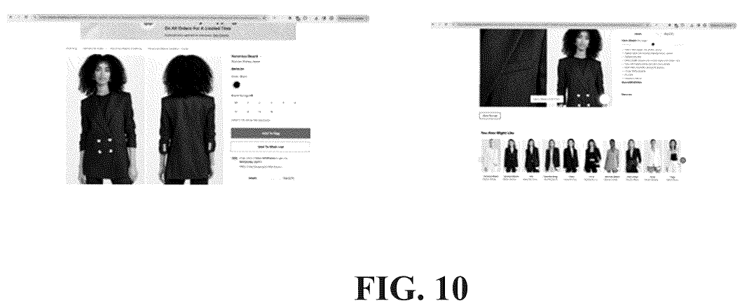

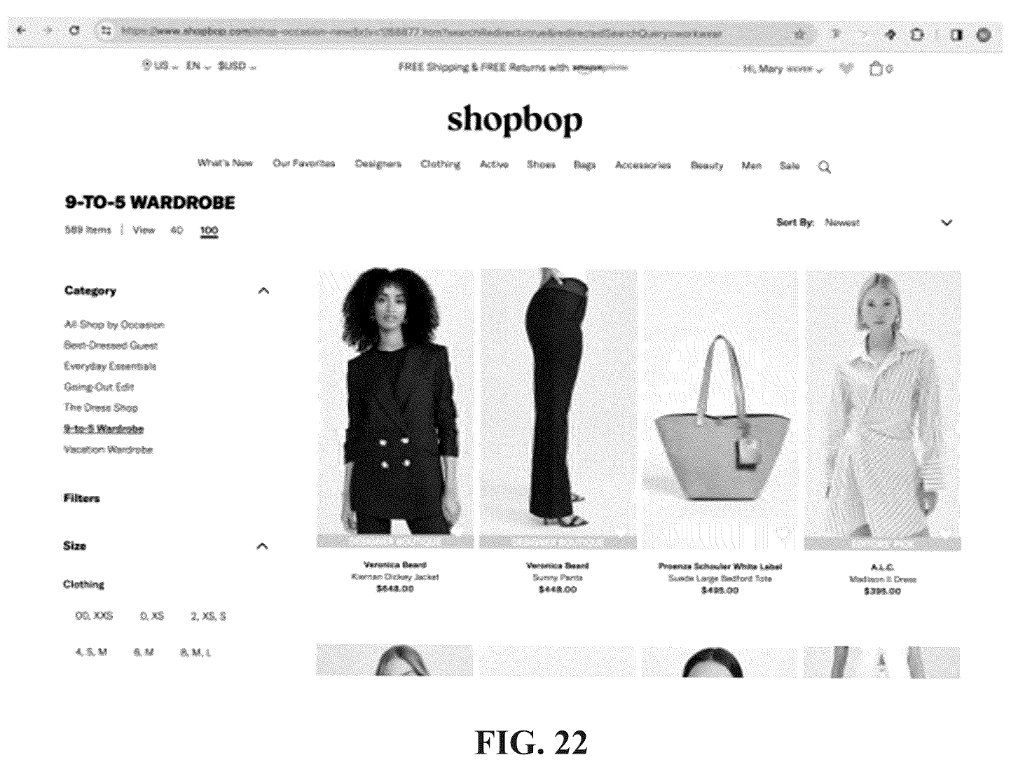

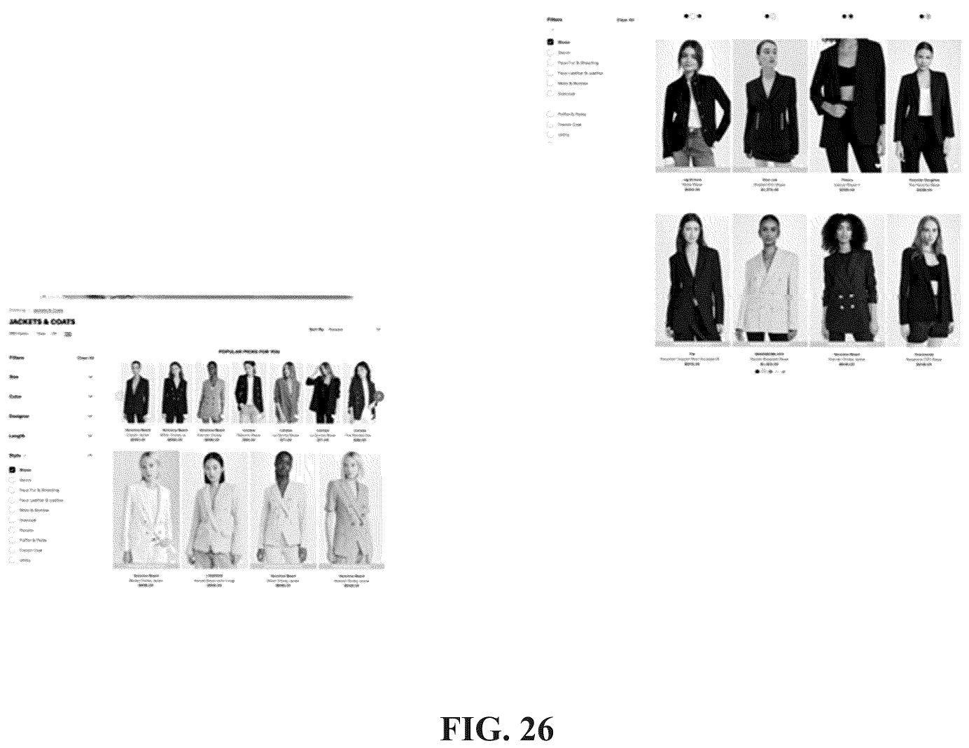

Once the data is pushed to the server, the data may be organized using the platform's standardized process to consolidate data from multiple sources. In one embodiment, a user checks out from a US fashion retailer after buying a garment and receives an email receipt (FIG. 9 shows a user received an email receipt after buying the “Kiernan Dickey Jacket” from Shop.com). Once the data is transferred, it may be parsed and organized. For example, based on the keyword “Jacket” in the title of the receipt (FIG. 9), the software categorizes the inventory item under one of the multiple defined categories for apparel called “Jackets & Coats” (FIG. 10). Additional metadata brought in shows that a web page on Shopbop.com has cataloged the inventory item as “Jackets & Coats” (FIG. 26). On a separate web page, the software finds that Shopbop.com has assigned the item the style category “Blazer” (FIG. 26). On a wholly separate and third webpage, the product is assigned to the “Occasion Pieces,” more specifically assigned to the “9-5” occasion piece (meaning a workwear piece you can wear to a 9-5 job) (FIG. 22). The shopper would never be able to see these identifiers in one place. On the items product page (FIG. 10), nowhere does it state that the item that falls under “Jacket & Coats” is a clothing style “Blazer” and “9-5” worn to work. These identifiers are scattered across multiple web pages. These additional identifiers may be necessary for tracking and resale purposes as they state the assigned and most likely use case the shopper who bought the garment for. Without these identifiers, the software might only capture the item as a Jacket and Coat, and the user would have to view copious amounts of jackets and coats, perhaps multiple pages which could be tedious and inefficient. However, by aggregating additional identifiers from multiple web pages, the digital inventory listings can be more personalized for the user, alleviate search, enhance functionality and visibility, and enrich resale listings. While this embodiment is an example of workwear, it can also be done for numerous other occasions such as date night, concerts, gym clothes, and other similar elements. Shopbop.com also does this for specific seasons. This may be important because Artificial Intelligence (AI) image technology may be limited in knowing if a pair of black pants may be a winter, fall, or other season piece, but the web pages provide detailed and accurate insights. For example, when a user buys the “Kiernan Dickey Jacket” from Shopbop.com, the software extracts the purchasing data from the email receipt (FIG. 9) and pulls additional details from multiple web pages. Based on the keyword “Jacket” in the title of the name, which may be present on the emailed receipt, Some embodiments may categorizes the inventory item under “Jackets & Coats.” On one example webpage, some embodiments may extract that Shopbop.com's has cataloged the inventory item as “Jackets & Coats” (FIG. 10); on another web page, the software finds the style category assigned to the inventory item may be “Blazer” (FIG. 26), and on a third web page it may be assigned to their “Occasion Pieces” webpage, more assigned explicitly to the “9-5” occasion piece (meaning a workwear piece you can wear to your 9-5 job) (FIG. 22). The shopper would not be able to see these identifiers in one place.

For an online physical and digital inventory, fashion retailers use inventory management systems to catalog items by category, color, subcategory, styling tags, descriptors, SKUs, and other similar elements. The inventory management systems differ across almost every brand and retailer website. This creates inconsistencies for shoppers, especially in women's fashion, as the inventory may be subject to short cycle trends (fast-changing products) and wide-ranging inventory types that can fall under a comprehensive list of categories, subcategories, and different styling tags all under different names and found on different web pages.

Each retailer and designer creates different standardization methods to organize their digital inventory. This includes a wide range of inventory management techniques to apply an inventory item's categories, subcategories, colors, names, sizing, and other similar elements. Within the US alone, there are discrepancies across sizing, categories, and other similar elements. This issue stems from the 19th and 20th centuries when no consistent sizing metrics and different-sized fashion mannequins were used across US companies. The issue continued to evolve and was exacerbated by the lack of regulation, market segmentations, and the introduction of vanity sizing in the US fashion industry. As a result, the online shopping experience for shoppers varies across each retailer and brand website.

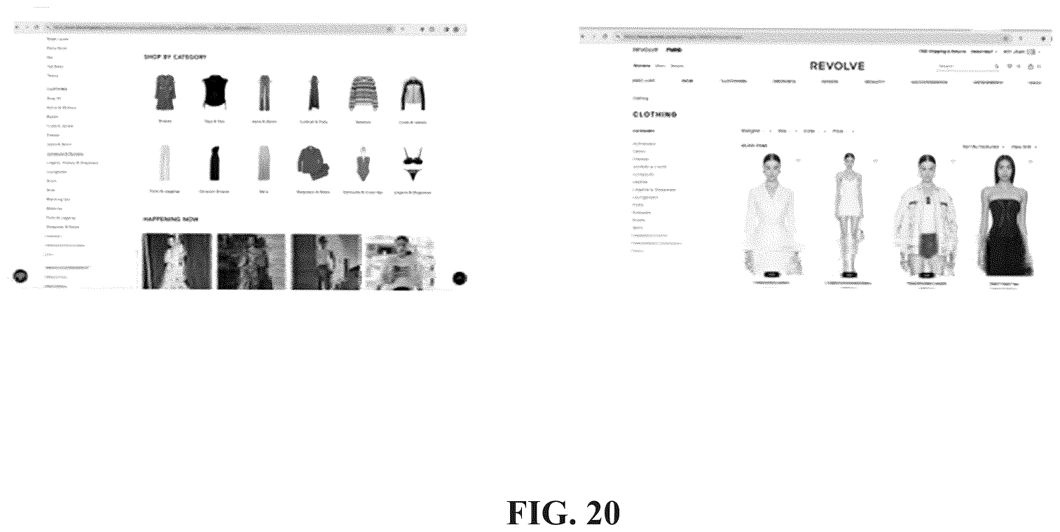

For example, to categorize clothing that may be worn at the gym, Bloomingdales.com, a US fashion retailer, calls the category “Active & Workout” (FIG. 20). In contrast, Revolve.com, another US fashion retailer, categorizes the same type of clothing as “Activewear” (FIG. 20). A second example of a lack of standardization may be that types of apparel categories differ across brands and retailer. For example, Bloomingdales.com has 17 categories for women's clothing (FIG. 20), while Revolve.com has 15 categories for women's clothing (FIG. 20). Bloomingdales.com categorizes “Blazers” and “Coats and Jackets” separately. Revolve does not have a category for blazers; they only have a “Jackets and Coats” category. They have “Blazers” as a subcategory of “Style Types” (FIG. 26), which falls under the main apparel category “Jackets & Coats.” As a result, the shopper must search more web pages to find the blazers. These are only two examples of the lack of standardization across hundreds of thousands of retailers in category, naming, product identifiers, and other similar elements. However, inconsistencies exist in sizing, fit, color, description, care, and other similar elements. This can make online shopping for women's clothing tedious and time-consuming as there is no consistency across retailers.

Some embodiments may include an organizational system with defined categories, subcategories, colors, styles, sizes, and other similar elements that may be defined (FIG. F). The software extracts data from thousands of brands. It uses the machine learning (ML) Model to create a standardized organizational platform by using a mapping system around defined identifiers for the category, subcategory, sizing, SKUs, styling tags, colors, and other similar elements. While the software standardizes the data to meet consistent metrics in an embodiment for organizational purposes, the original data points from the retailer it purchased are also saved.

For example, when a user buys the “Kiernan Dickey Jacket” from Shopbop.com, the software extracts the purchasing data from the email receipt (FIG. 9) and pulls additional details from multiple web pages. Based on the keyword “Jacket” in the title of the name, which may be present on the emailed receipt, software categorizes the inventory item under “Jackets & Coats.” One web page may extract that Shopbop.com's has cataloged the inventory item as “Jackets & Coats” (FIG. 10). On another web page, the software finds the style category assigned to the inventory item may be “Blazer” (FIG. 26), and on a third web page it may be assigned to their “Occasion Pieces” webpage, more assigned explicitly to the “9-5” occasion piece (meaning a workwear piece you can wear to your 9-5 job) (FIG. 22). The shopper would not be able to see these identifiers in one place.

Some embodiments may process the email receipt through its model and Shopbop.com's identifiers: “Jackets and Coats,” “9-5”, or “Blazers.” Some embodiments may have a predefined category called “Jackets and Coats” and a predefined subcategory called “Blazers,” which it labels the inventory item. Due to the data from Shopbop.com the inventory item may be in the “9-5” tags, and the item “Workwear” may be in the Occasion tags for the user. Some embodiments may automatically tag the category, subcategory, sizing, and occasion for the user. While the UX/UI may use a category, subcategory, or tag—they are all organizational identifiers assigned to an inventory item.

Some embodiments may scrap thousands of data pages and built a system that maps to one organizational platform to make consolidation across thousands of retailers efficient. For example, Some embodiments may have created occasion tags such as “Workwear.” The system created a synonym after scanning thousands of websites called “9-5”—a synonym for the occasion tag “Workwear.” Some embodiments may build out hundreds of rules for synonyms to help catalog the item correctly and save the user time. Additionally, software may save data on the digital listing that the item may be in the 9-5 categories on Shopbop.com. This detailed and standardized system for cataloging may be far more extensive and accurately based on the original identifiers created by the retailer and how they marketed it to their target audience. It saves the user time as some embodiments may automatically and accurately tag categories, occasions, colors, and styles from across retailers into one organized management platform.

As discussed previously, it may be desirable to aggregate and enrich the captured data to allow analysis from a multi-dimensional data model. A data repository may be a collection of resources that can be accessed to retrieve electronically stored data. A data repository facilitates data analysis and reporting that may, for example, be performed by software applications disclosed herein. The data repository layer may also store metadata about the user's inventory items (individual listing and Digital Personal Possession Portfolio). Metadata describes how, when, and by whom a particular data set was collected and how the data may be formatted. The metadata may include annotations. The annotations may specify rules about how facts corresponding to data dimensions can be aggregated and/or transformed. A data dimension may be a data attribute or element that categorizes each item in a data set into a category, group, or region. Data dimensions include customer data, product data (e.g., text description of the product, additional photos, measurements), seller data, sales data, date data, and location data. When the server captures the data from multiple sources, additional information may also be added.

The method further includes, at step 108, generating a digital inventory. The digital inventory may be generated from the captured data. For example, for each piece of clothing or other product associated with the user, a data object or other data structure may be created from the captured data. Each data object or structure may contain a particular item's captured data. For example, the data object for a particular shirt may include the brand, retailer, purchase date, and purchase price that may be captured from the user's email inbox, in addition to descriptions and photos of the shirt from the manufacturer's website and information on value pulled from resale sites.

The digital inventory listing may be created using retailer web pages, receipt data, and the platform's organizational identifiers. It may be created in a way that allows for multiple management capabilities on the platform. Management capabilities may include planning in a digital planner. It may also include the user using their digital listing to understand the real-time value and make an informed decision about resale.

The method further includes, at step 110, viewing and managing the digital inventory. This allows users to navigate their digital personal possession portfolio to see all the products in the system. The system may allow the user to search for items, sort items, piece items together to create a digital outfit, create notes or annotations about an item or outfit, view data and insights on the portfolio, view value estimations on the portfolio or individual listings, and the like.

Machine learning (ML) uses computer algorithms that can improve automatically through experience and data. Machine learning algorithms build a model based on sample or training data to make predictions or decisions without being explicitly programmed. Machine learning algorithms are used where it is unfeasible to develop conventional algorithms to perform the needed tasks.

In certain embodiments, instead of, or in addition to, performing the functions described herein manually, the system may perform some or all of the functions using machine learning or artificial intelligence. Thus, in certain embodiments, machine learning-enabled software relies on unsupervised and/or supervised learning processes to perform the functions described herein in place of a human user. For example, ML can be applied to provide additional enrichment of the created digital listing. For example, possessions may be listed under different categories on different merchants. A pair of jeans may be under the category of denim on one merchant and pants on another merchant. A standardized ML algorithm may be applied to create a standardized inventory management platform.

Machine learning may include identifying one or more data sources and extracting data from the identified data sources. Instead of or in addition to transforming the data into a rigid, structured format, in which specific metadata or other information associated with the data and/or the data sources may be lost, incorrect transformations may be made, or the like, machine learning-based software may load the data in an unstructured format and automatically determine relationships between the data. Machine learning-based software may identify relationships between data in an unstructured format, assemble the data into a structured format, evaluate the correctness of the identified relationships and assembled data, and/or provide machine learning functions to a user based on the extracted and loaded data, and/or evaluate the predictive performance of the machine learning functions (e.g., “learn” from the data).

In certain embodiments, machine learning-based software assembles data into an organized format using one or more unsupervised learning techniques. Unsupervised learning techniques can identify relationships between data elements in an unstructured format.

In certain embodiments, machine learning-based software can use the organized data derived from the unsupervised learning techniques in supervised learning methods to respond to analysis requests and to provide machine learning results, such as a classification, a confidence metric, an inferred function, a regression function, an answer, a prediction, a recognized pattern, a rule, a recommendation, or other results. Supervised machine learning, as used herein, comprises one or more modules, computer-executable program code, logic hardware, and/or other entities configured to learn from or train on input data, and to apply the learning or training to provide results or analysis for subsequent data.

Machine learning-based software may include a model generator, a training data module, a model processor, a model memory, and a communication device. Machine learning-based software may be configured to create prediction models based on the training data. In some embodiments, machine learning-based software may generate decision trees. For example, machine learning-based software may generate nodes, splits, and branches in a decision tree. Machine learning-based software may also calculate coefficients and hyperparameters of a decision tree based on the training data set. In other embodiments, machine learning-based software may use Bayesian algorithms or clustering algorithms to generate predicting models. In other embodiments, machine learning-based software may use association rule mining, artificial neural networks, and/or deep learning algorithms to develop models. In some embodiments, machine learning-based software may utilize hardware optimized for machine learning functions, such as a Field Programmable Gate Array (FPGA), to improve the efficiency of the model generation.

The method further includes, at step 112, automatically cross-listing one or more items to one or more third-party resellers. A connection to various third-party reseller marketplaces may be established, for example, through a web browser or an Application Programming Interface (API). Through the API, digital listing data may be posted to the marketplaces, data from the marketplaces may be accessed, and data on the marketplaces may be modified. The digital listings may be customized for each marketplace and automatically generated and posted to the marketplaces simultaneously (or nearly simultaneously). This is unique and beneficial to the consumer as it does not require them to input data into the form manually and avoids the user having to search multiple web pages, email, and credit card data.

It is appreciated that the methods for dynamically aggregating, enriching, presenting, and managing data described herein may use, in some embodiments, a publisher-subscriber model. For example, the method may include receiving, by a data aggregation server implemented between a plurality of remote subscribing client applications and a plurality of distributed remote databases, from each distributed remote database in the plurality of distributed remote databases via a network, data and metadata associated with a user's digital possession portfolio. The data aggregation server may then aggregate this received data and metadata from all the distributed remote databases to create the user's digital possession portfolio. The data aggregation server may then indicate available data associated with a user's digital possession portfolio to which a client application may subscribe. In response to a subscriber request, the data aggregation server may analyze the data repository for data associated with the user's digital closet and provide access to the data. It is appreciated that the data aggregation server may send the information to the subscribing client directly or may send connection information, providing a network connection path for allowing the subscribing client to retrieve the data from a remote database from which the data.

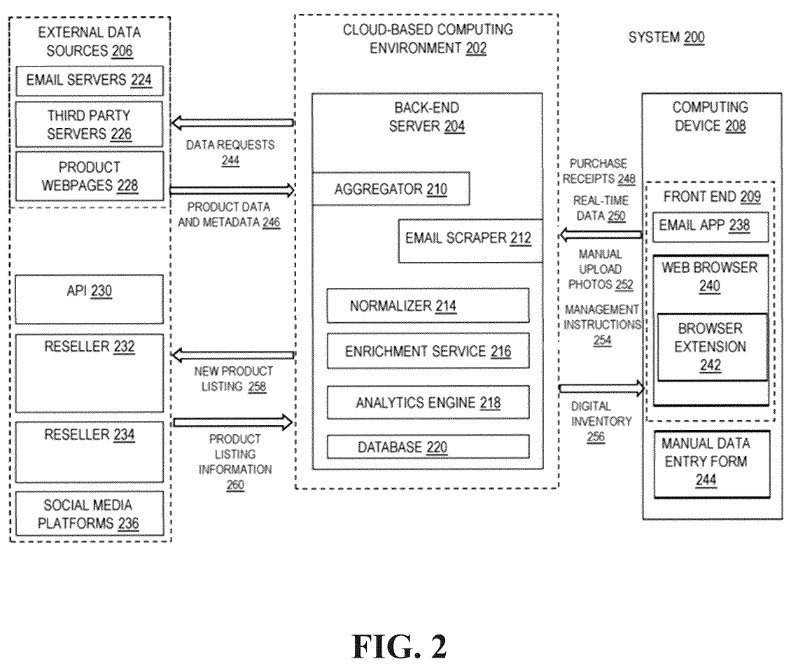

FIG. 2 depicts a system 200 for providing and managing a personal digital possession portfolio system according to an embodiment of the subject matter described herein. Referring to FIG. 2, system 200 includes a back-end server 204 implemented within a cloud-based computing environment 202. The back-end server 204 includes an aggregator 210, an email scraper 212, a normalizer 214, an enrichment service 216, an analytics engine 218, and a database 220. The back-end server 204 may be configured to communicate with one or more computing devices 208. The computing device 208 may be any computing device, such as a mobile device, laptop, or desktop computer. The front-end 209 of computing device 208 may include an email application 238 and a web browser 240, which may include a third-party application extension or browser extension 242. The back-end server 204 is configured to receive purchase receipts 248, real-time data 250, manually uploaded photos 252, and/or management instructions 254 from the computing device 208 and to send digital inventory data 256 to the computing device 208. The back-end server 204 may receive data, such as product data and metadata 246, via the aggregator 210. The aggregator 210 captures and/or collects incoming data via application programming interfaces (“APIs”) 230 and/or raw object data from third-party servers 226. The third-party servers 226 may include, for example, the user's email server, a retailer's POS server, or a retailer's online website server. The incoming data may come from one or more external data sources 206. As illustrated in FIG. 2, for example, the external data sources 206 may include email servers 224, third-party server 226, product webpages 228, multiple third-party resellers 232 and 234, social media platforms 236, or the like.

Details on how the system automatically cross-lists items on third-party websites and adapts the digital inventory listing to meet the requirements of different reseller sites is described herein.

As mentioned above, system 200 further provides for automated generation and posting of one or more digital possession items to one or more third-party reseller websites. This automated generation and posting process provides cross-listing capabilities that enable the user to list an item for sale on multiple online marketplaces simultaneously from the system. This cross-listing may occur without user input 200. Cross-listing allows users to list items on multiple third-party sites, such as eBay®, from one centralized platform. The system may establish a connection to various marketplaces through integration, such as through a web browser or an API.

In one embodiment, the system may use one or more APIs each marketplace provides to communicate with the marketplace systems. Through the API, the system may post data to the marketplaces, access data on the marketplaces, and/or modify data on the marketplaces. This includes creating new listings and managing existing listings. In addition, the system may use APIs to update inventory on the marketplaces and retrieve sales data from the marketplace. This differs from all solutions that exist today in resale (eBay, Etsy, Vinted) and cross-listing sites (Vendoo, OneShop, ListPerfectly). User may manually upload their listings. This may include AI image technology that tags generic physical items not specific to the user's purchase but excludes the exact name, exact color title, size purchased, price paid, and other similar elements, that may be gathered using real-time purchasing data aggregation method.

Current cross-listing solutions and resale sites do not use real-time captured purchasing data. Additionally, it differs from all of today's cross-listing solutions, such as Vendoo, OneShop, ListPerfectly, and other similar elements, as the digital listings automatically created can automatically trigger the answers to the forms of multiple marketplaces at once, which have unique forms with different categories and answers similar categories using different terms. On today's cross-listing sites, the user can access completed forms on multiple marketplaces without the user ever doing any work (listings can be edited if necessary.) These forms are not standardized, and the questions and answers differ across all marketplaces. For example, eBay's form (FIG. 21) has different categories, subcategories, styling tags, and other similar elements compared to other marketplaces. Like the inconsistencies across the inventory management of fashion retailers and brands described, the same inconsistencies exist across resale sites, which all use different inventory management identifiers for categories, colors, sizes, style tags, and other similar elements to manage the items on their sites. These varying inventory management systems create different shopping, selling, and buying experiences for the user. The inconsistencies exist across the webpages (filtering, search, and other similar elements) and the upload inventory form when a seller wants to sell their inventory item on eBay, and other similar elements The selling forms differ in length, type of question, and answer capabilities. Some embodiments may automatically fill out the forms on behalf of the user using the data initially extracted at the point of purchase.

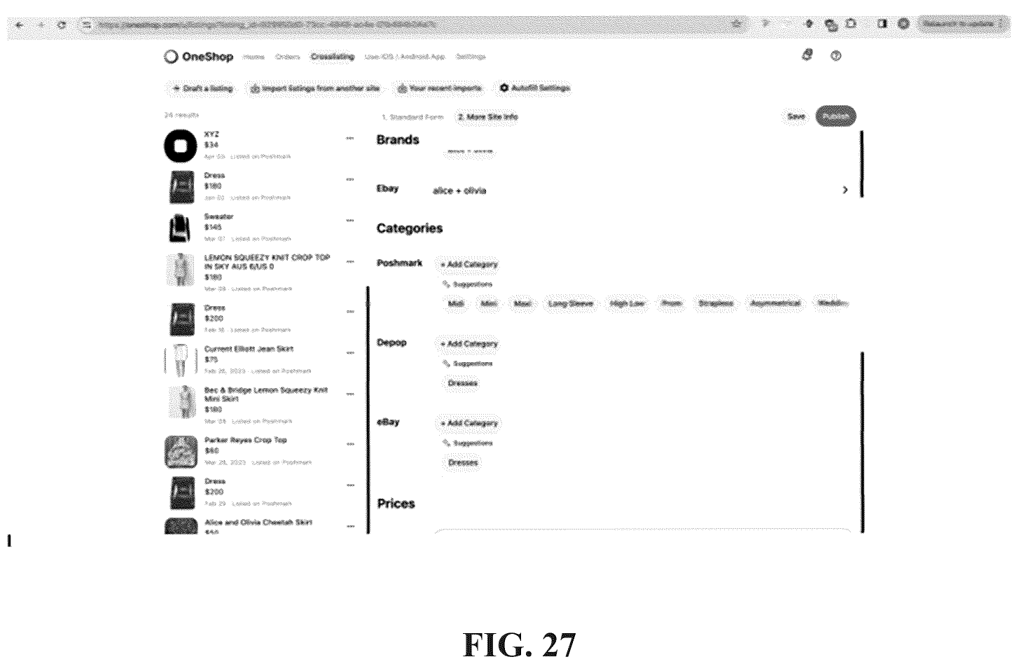

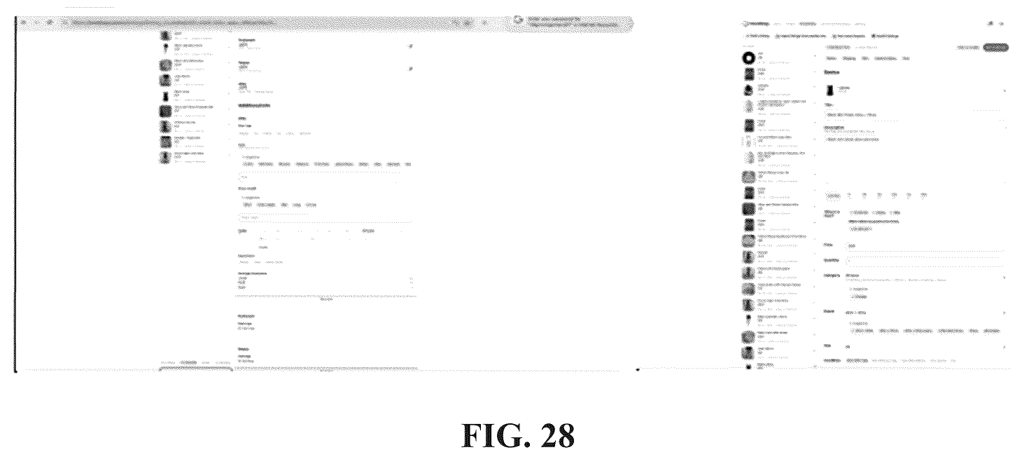

For example, when a consumer uses OneShop, a cross-listing site, they must manually fill in details on the garment out of the “Standard Form.” This includes categories (ex., a Dress), inputting the price paid, and other similar elements (FIG. 27). Once completed, the consumer must also input specific identifiers such as styling tags or niche identifiers to which the standard form does not equate a value point (FIG. 28). Some embodiments may automatically map the purchasing insights to complete the entire form, including name, description, size purchased, color, price paid, and other similar elements It also uses the identifiers found from multiple web pages at the point of purchase to identify key tags, such as styling identifiers, without any manual input from the consumer. Some embodiments may use a technology that maps the keywords from the purchasing data to identify the tags. It is especially unique because the software and its organizational mapping can be used to answer the questions of inventory upload forms across multiple websites simultaneously.

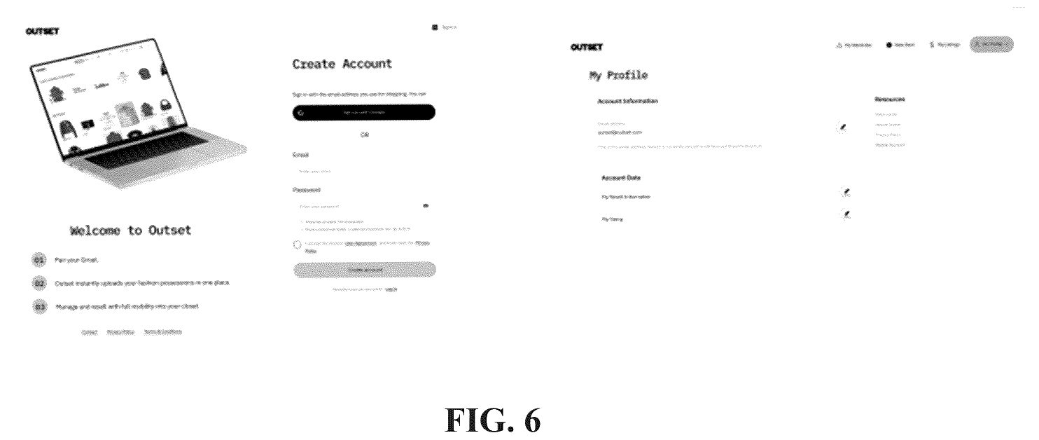

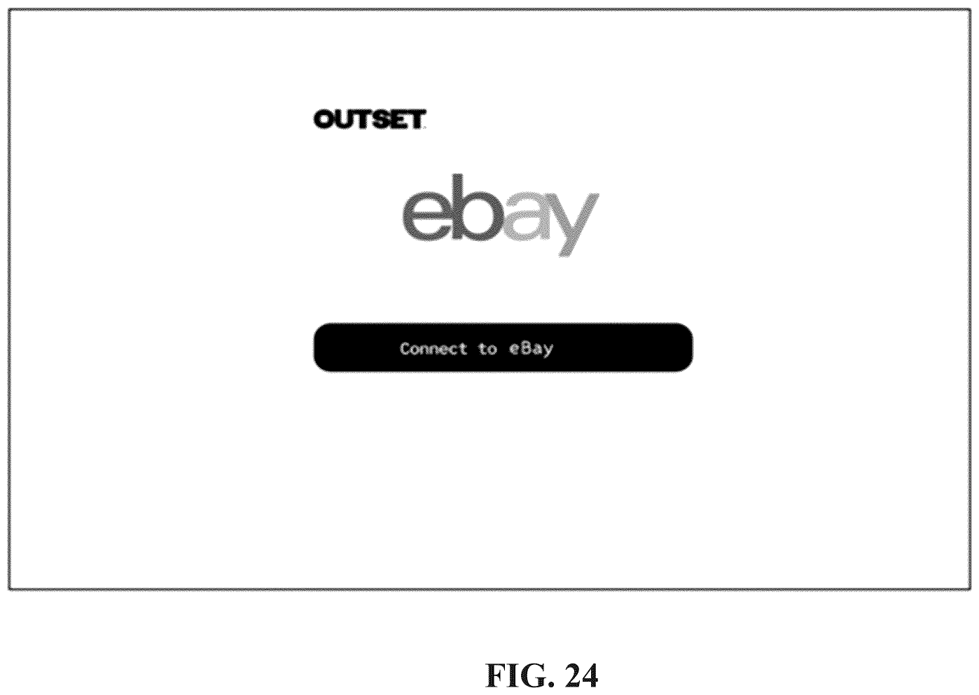

In one embodiment, during the sign-up process, a user can sync their Gmail account (FIG. 6) and their legacy resale platform accounts such as eBay, and other similar elements (FIG. 24). The server connects to eBay, a legacy resale site API. It may bring the user to the login screen on the legacy platform by programmatically stimulating the login process by sending an HTTP POST request to the legacy resale platform's login endpoint, passing the username and password (this may be dependent on the legacy site). The legacy resale platform authentication server processes the login request, verifies the user's credentials, generates a token, and returns the token in the HTTP response body or as a cookie. Some embodiments may extract the token from the response or cookie and stores it securely for future use. Once the login credentials have been inputted, the server processes the login request, verifies the users' credentials, and generates a token.

The user has multiple ways to cross-list, including posting multiple inventory items at once or setting up rules to automatically cross-list without logging into the platform. The user may set up rules at the signing process after syncing that allow the user to select inventory for future resale or create rules such as “occasion-based dresses are automatically resold 3 months post purchase date.” Users could create rules so that listings automatically post directly after the point of purchase.

In one embodiment, when a user buys the “Kiernan Dickey Jacket” from Shopbop.com (FIG. 9), the software extracts the purchasing data from the email receipt and pulls additional details from multiple web pages. Based on the keyword “Jacket” in the name's title, which may be present on the emailed receipt, Some embodiments may categorize the inventory item into their pre-defined categories under “Jackets & Coats.” Additional data pulled from multiple web pages online allowed some embodiments to “know” it may be a “Blazer,” a specific subcategory of “Jackets Coats. On an additional web page, some embodiments may find it is found under the category “9-5,” and as a result, some embodiments may tags the garment under the occasion-based category “workwear” as “9-5” is a synonym for a predefined occasion based category called “Workwear” in an example system. Within some example platforms, the user has all their digital listings in one place with tagged identifiers, allowing for easy search and visibility for the user. When the user wants to cross-list, they merely select the item, or multi-select items, and hit sell to the selection of legacy sites like eBay. Some embodiments may automatically fills out the form on behalf of the user. They can review the listing or merely post it on the legacy platform. As previously mentioned, Some embodiments may automatically tag the category, subcategory, sizing, and styling. Some embodiments may be programmed so that the category (tops, pants, jackets, and other similar elements) may be at the highest level and the occasion tag is very detailed and informative. Some example platforms may be programmed to use the tags to fill out the listings. For example, on eBay, there may be a category called “Suits & Suit Separates” for work-specific suit items and a category called “Jackets, Coats, & Vests” (Figure C). A work category for suit pieces does not exist in most other marketplaces, but a category called “Jackets & Coats” may be common (FIG. 21). When the user sells the item on eBay, the software knows that the item is a work jacket and can be used in the “Suits & Suit Separates.” This benefits the user as their listing is accurate and has the most niche use case, which helps buyers find their item. A buyer looking for workwear may find the listing much faster than if it was just listed under jackets and coats.

Similarly, there may be inconsistencies in various areas of the form color, another example. eBay has the color beige, while Poshmark uses the color tan in its predetermined color fields. Some embodiments may include an ML model, which builds out predetermined colors, knows that tan and beige are very similar. When the user sells an item under the tan color identifier, it may also list it under beige on eBay.

The system may allow the user to modify the created digital listing further. In addition, the system may modify the digital listing into a format specific to a particular marketplace. For example, the digital listing may be modified so that the posting details are formatted and aligned correctly for the relevant APIs of marketplaces, which all differ. This further saves the user time as Some embodiments may modify automated listings across multiple marketplaces. The system may then create a listing on one or more marketplaces using integrations, connections, and/or APIs with each marketplace to create a listing with the same information on each platform. When a sale (or other relevant transaction or interaction) occurs on one marketplace, the system automatically updates the user and the inventory on all other marketplaces to reflect the new stock level. In other words, if a specific product is simultaneously cross-listed on three reseller marketplaces, and a sale occurs on one of those three reseller marketplaces, then the system automatically updates the other two marketplaces to show that that specific product may be no longer available.

In various embodiments, either the front-end 209 of the computing device 208 or the back-end server 204 generates a listing from the data stored in the database 220, such as product, sales, inventory, and pricing information. The back-end server 204 manages incoming and outgoing requests to the third-party resellers 232 and 234. These requests may be managed using API 230, which allows the back-end server 204 to connect with the reseller marketplaces. For example, API 230 allows the back-end server 204 to communicate with these marketplaces and retrieve and update data, such as product information and sales data. This integration also enables the platform to manage inventory and pricing across multiple marketplaces simultaneously. As a result, the back-end server 204 provides inventory management that enables sellers to manage, track, and adjust their inventory across multiple marketplaces from a single location. In addition, the back-end server 204 provides order management that enables sellers to track their orders across multiple marketplaces from a single location. The back-end server 204 further enables the retrieval of sales data from each marketplace and provides insights that enable sellers to make data-driven decisions and optimize their sales strategies. The system may connect to one or more APIs of a marketplace by retrieving an access token, which is then used to authenticate requests made to the marketplace via the API. For example, the platform sends an HTTP POST request to the API endpoint. The marketplace API processes the request and returns the token. The token may be used to process subsequent requests made by the platform to the marketplace APL. The back-end server 204 may provide new product listing data 258 to one or more resellers and receives product listing information 260 from one or more resellers.

The database 220 may be an open-source database such as the MongoDB® database, the PostgreSQL® database, or the like. An additional front-end component may be configured to provide administrator access to a secure web portal. The administrator access secure web portal may be configured to provide status and control of the back-end server 204.

In some embodiments, the back-end server 204 may also use one or more transfer protocols such as a hypertext transfer protocol (HTTP) session, an HTTP secure (HTTPS) session, a secure sockets layer (SSL) protocol session, a transport layer security (TLS) protocol session, a datagram transport layer security (DTLS) protocol session, a file transfer protocol (FTP) session, a user datagram protocol (UDP), a transport control protocol (TCP), or a remote direct memory access (RDMA) transfer protocol.

The back-end server 204 may be implemented on one or more physical servers implemented within the cloud-based computing environment 202. The back-end server 204 may include a non-transitory computer-readable medium, including a plurality of machine-readable instructions which, when executed by one or more processors of the one or more servers, are adapted to cause the one or more servers to perform a method of organization network analysis. The method may include the method described in FIG. 1.

Thus, the system disclosed herein may be implemented as a client/server type architecture but may also be implemented using other architectures, such as cloud computing, software as a service model (SaaS), a mainframe/terminal model, a stand-alone computer model, a plurality of non-transitory lines of code on a computer-readable medium that can be loaded onto a computer system, a plurality of non-transitory lines of code downloadable to a computer, and the like.

The system may be implemented as one or more computing devices that connect to, communicate with and/or exchange data over a link to interact with each other. Each computing device may be a processing unit-based device with sufficient processing power, memory/storage, and connectivity/communications capabilities to connect to and interact with the system. For example, each computing device 208 may be an Apple iPhone or iPad device, a Blackberry or Nokia device, a mobile device that executes the Android operating system, a personal computer, a tablet computer, a laptop computer, or the like, and the system not be limited to operating with any particular computing device. The link may be any wired or wireless communications link that allows the computing devices 208 and the system to communicate with each other. In one example, the link may be a combination of wireless digital data networks that connect to the computing devices and the Internet. The system may be implemented as one or more server computers (all located at one geographic location or in disparate locations) that execute a plurality of lines of non-transitory computer code to implement the functions and operations of the system as described herein. Alternatively, the system may be implemented as a hardware unit in which the functions and operations of the back-end system are programmed into a hardware system. In one implementation, one or more server computers may use Intel® processors, run the Linux operating system, and execute Java, Ruby, Regular Expression, Flex 4.0, SQL and other similar elements.

In some embodiments, each computing device 208 may further comprise a display and a browser application to display information generated by the system 200, such as the Digital Possession Items and/or the Digital Possession Portfolio. The browser application may be a plurality of non-transitory lines of computer code executed by a processing unit of the computing device 208. Each computing device 208 may also have the usual components of a computing device, such as one or more processing units, memory, permanent storage, wireless/wired communication circuitry, an operating system, and other similar elements.

System 200 may further comprise a server (that may be software-based or hardware-based) that allows each computing device 208 to connect to and interact with system 200, for example, by sending information and receiving information from the computing devices that one or more processing units may execute. System 200 may further comprise software- or hardware-based modules and database(s) for processing and storing content associated with the system, metadata generated by the system for each piece of content, user preferences, and the like.

In one embodiment, system 200 includes one or more processors, servers, clients, data storage devices, and non-transitory computer-readable instructions that, when executed by a processor, cause a device to perform one or more functions. It is appreciated that a single device may perform the functions described herein or may be distributed across multiple devices.

When a user interacts with the system 200, the user may use a front-end client application 209. The client application may include a graphical user interface allowing users to select one or more digital files. The client application may communicate with a back-end cloud component using an application programming interface (API) comprising a set of definitions and protocols for building and integrating application software. As used herein, an API may be a connection between computers or computer programs that is a software interface offering a service to other pieces of software. An API specification may be a document or standard describing how to build or use such a connection or interface. A computer system that meets this standard may be said to implement or expose an API. The term API may refer either to the specification or to the implementation.

Software-as-a-service (SaaS) is a software licensing and delivery model in which software is licensed on a subscription basis and is centrally hosted. Users typically access SaaS using a thin client, e.g., via a web browser. SaaS is considered part of the nomenclature of cloud computing.

Many SaaS solutions are based on a multitenant architecture. With this model, a single version of the application, with a single configuration (hardware, network, operating system), may be used for all customers (“tenants”). The application may be installed on multiple machines (called horizontal scaling) to support scalability. “Software multitenancy” refers to a software architecture in which a single software instance runs on a server and serves multiple tenants. Systems designed in such a manner are often called shared (in contrast to dedicated or isolated). A tenant may be a group of users sharing common access with specific privileges to the software instance. With a multitenant architecture, a software application may be designed to provide every tenant a dedicated share of the instance—including its data, configuration, user management, tenant individual functionality, and non-functional properties.

The back-end cloud component 204 described herein may also be called a SaaS component. One or more tenants may communicate with the SaaS component via a communications network like the Internet. The SaaS component may be logically divided into one or more layers, each layer providing separate functionality and being capable of communicating with one or more other layers.

Cloud storage may store or manage information using a public or private cloud. Cloud storage is a model of computer data storage in which the digital data may be stored in logical pools. The physical storage spans multiple servers (sometimes in multiple locations), and the physical environment may be typically owned and managed by a hosting company. Cloud storage providers are responsible for keeping the data available and accessible and protecting and running the physical environment. People and/or organizations buy or lease storage capacity from the providers to store user, organization, or application data. Cloud storage services may be accessed through a co-located cloud computing service, a web service API, or applications that utilize the APL.

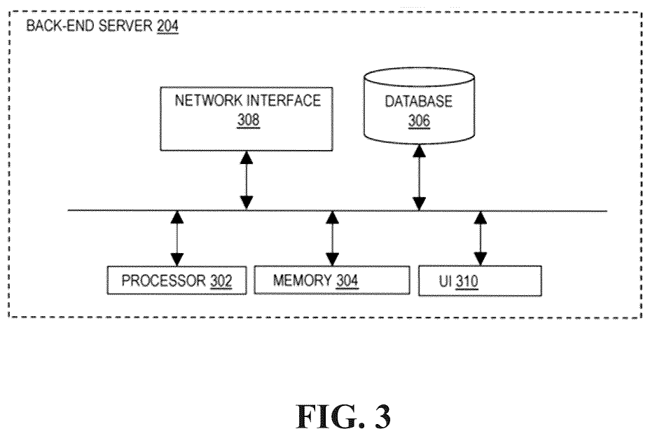

FIG. 3 illustrates an example block diagram of one embodiment of the back-end server 204 of FIG. 2. Referring to FIG. 3, the back-end server 204 may include at least one processor 302, a main memory 304, a database 306, a network interface 308, and a user interface (UI) 310.

Processor 302 may be a multi-core server-class processor suitable for hardware virtualization. The processor may support at least a 64-bit architecture and a single instruction multiple data (SIMD) instruction set. The main memory 304 may include volatile memory (e.g., random-access memory) and non-volatile memory (e.g., flash memory). The database 306 may include one or more hard drives.

The network interface 308 may provide one or more high-speed communication ports to the data center switches, routers, and/or network storage appliances. The data center network interface 308 may include high-speed optical Ethernet, InfiniBand (IB), Internet Small Computer System Interface (iSCSI), and/or Fibre Channel interfaces. The UI 310 may support local and/or remote configuration of the back-end server 204 by an administrator.

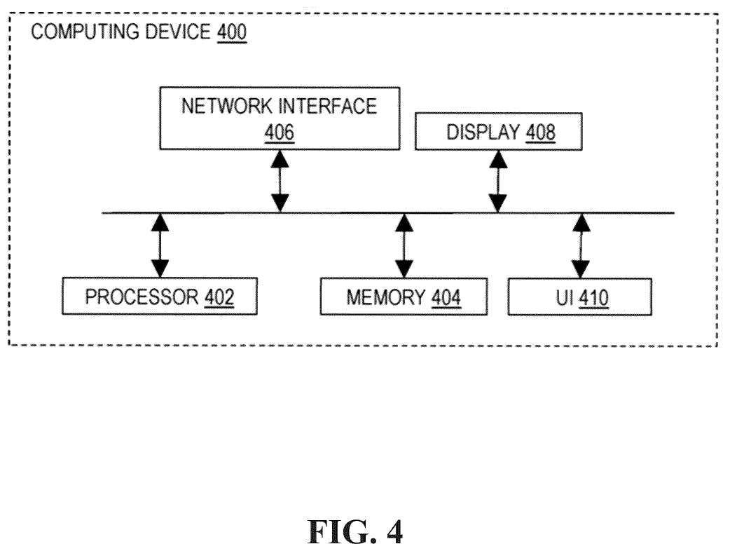

FIG. 4 depicts a block diagram illustrating one embodiment of a computing device 400. Referring to FIG. 4, the computing device may be a computing device 208 of FIG. 2. The computing device 400 may include at least one processor 402, a memory 404, a network interface 406, a display 408, and a UI 410. The memory 404 may be partially integrated with the processor 402. The UI 410 may include a keyboard and a mouse. The display 408 and the UI 410 may provide any of the GUIs in the embodiments of this disclosure. The computing device 400 may be a mobile device, such as a smartphone or a smart tablet, including a camera, WAN radios, and LAN radios. In some embodiments, the mobile device may be a laptop, a tablet, or the like.

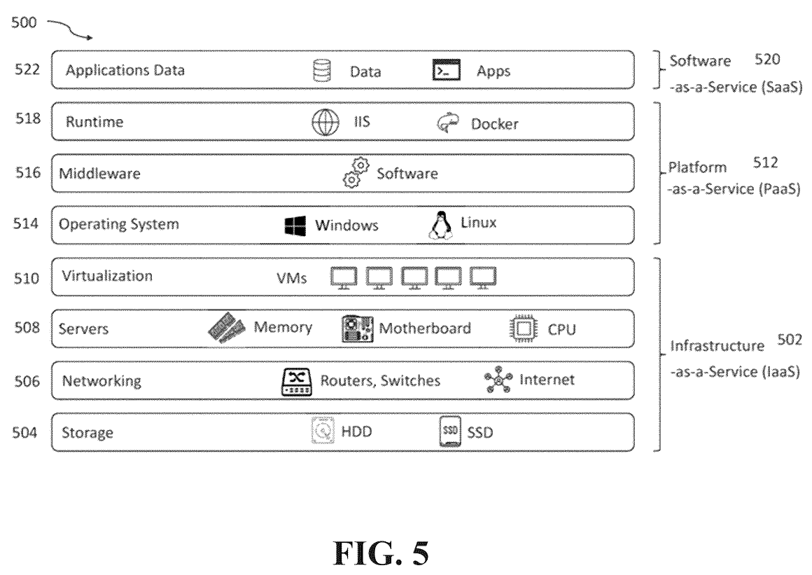

FIG. 5 is an illustration of an exemplary software-as-a-service (SaaS) model for providing and managing a personal digital wardrobe according to an embodiment of the subject matter described herein. Referring to FIG. 5, functionality 500 can be logically divided into layers. Layers may be ordered from the least to the greatest abstraction of underlying physical resources. Layers may be divided into groups based on standard features for simplicity when referring to or billing functions associated with each group.

Infrastructure 502 includes storage function 504, networking function 506, server function 508, and virtualization function 510. Infrastructure functions 504-510 may be bundled and provided to one or more tenants as a service, referred to as Infrastructure-as-a-Service (IaaS). IaaS may include a collection of physical and virtualized resources that provide consumers with the basic building blocks needed to run applications and workloads in the cloud.

Storage function 504 provides storage of data without requiring the user or tenant to be aware of how this data storage may be managed. Three types of cloud storage that may be provided by storage function 504 are block storage, file storage, and object storage. Object storage may be the most common mode of storage in the cloud because it may be highly distributed (and thus resilient), data can be accessed easily over Hypertext Transfer Protocol (HTTP), and performance scales linearly as the storage grows.

Networking function 506 in the cloud may be a software-defined networking in which traditional networking hardware, such as routers and switches, are made available programmatically, typically through APIs.

Server function 508 refers to various physical hardware resources associated with executing computer-readable code that may not be otherwise part of the virtualized network resources in networking function 506 or storage function 504. IaaS providers manage large data centers, typically worldwide, that contain servers powering the various layers of abstraction on top of them and are made available to end users. In most IaaS models, end users do not interact directly with the physical infrastructure (e.g., memory, motherboard, CPU), but it may be provided as a service.

Virtualization function 510 virtualizes underlying resources via one or more virtual machines (VMs). Virtualization relies on software to simulate hardware functionality and create a virtual computer system. A virtual computer system may be known as a “virtual machine” (VM): a tightly isolated software container with an operating system and application inside. Each self-contained VM may be completely independent. Putting multiple VMs on a single computer enables several operating systems and applications to run on just one physical server, or “host.” A thin layer of software called a “hypervisor” decouples the virtual machines from the host and dynamically allocates computing resources to each virtual machine as needed. Providers manage hypervisors, and end users can then programmatically provision virtual “instances” with desired amounts of computing and memory (and sometimes storage). Most providers offer both CPUs and Graphical Processing Units (GPUs) for different types of workloads.

Platform 512 includes operating system function 514, middleware function 516, and runtime function 518. Infrastructure functions 504-510 and platform functions 514-518 may be bundled and provided to one or more tenants as a service, referred to as Platform-as-a-Service (PaaS). In the Platform-as-a-Service (PaaS) model, developers rent everything needed to build an application, relying on a cloud provider for development tools, infrastructure, and operating systems.

Operating system function 514 refers to a PaaS vendor providing and maintaining the operating system that developers use and the application runs on. For example, Windows and Linux operating systems may be installed in virtual machines, and Windows or Linux applications may be run within the operating system.

Middleware function 516 may be the software between user-facing applications and the machine's operating system. For example, middleware may allow software to access input from the keyboard and mouse. Middleware may be necessary for running an application, but end users don't interact with it. Relatedly, middleware function 516 may also include tools that may be necessary for software development, such as a source code editor, a debugger, and a compiler. These tools may be offered together as a framework.

Runtime function 518 may be software code that implements portions of a programming language's execution model. A runtime system or runtime environment implements portions of an execution model. Most programming languages have some form of runtime system that provides an environment in which programs run. This environment may address issues including application memory management, how the program accesses variables, mechanisms for passing parameters between procedures, interfacing with the operating system, and otherwise. The compiler makes assumptions depending on the specific runtime system to generate correct code. Typically, the runtime system may have some responsibility for setting up and managing the stack and heap and may include features such as garbage collection, threads, or other dynamic features built into the language.

Software 520 includes applications and data function 522. Infrastructure functions 504-510, platform functions 514-518, and software function 522 may be bundled together and provided to one or more tenants as a service, referred to as Software-as-a-Service (SaaS). Applications and data function 522 may be the application and associated data created and managed by the user. For example, an application programmed by the user to provide certain functionality disclosed herein may be exposed to the end user via a front-end interface such as a web browser or dedicated front-end client application. Neither the front-end user nor the back-end developer may be required to manage or maintain services provided by platform 512 and infrastructure 502. This contrasts with on-site hosting, which has the same functionality.

The following description relates to an exemplary user experience journey for a user. In this example scenario, the personal digital inventory management system described herein may be referred to as a “digital wardrobe,” digital closet,” “Outset.com,” “Outset Style,” or simply “Outset.”

FIG. 6 depicts screenshots of an exemplary user interface for creating a user account and entering user information associated with a personal digital wardrobe according to an embodiment of the subject matter described herein. Referring to FIG. 6, at left is a screen presented to the user to begin creating an account on a webpage, e.g., Outset.com. At the right is a screen for a new account that asks the user to provide their email address, password, name, birthdate, and sizing information, such as height, pant size, top size, and bra size. After creating an account, the user may begin capturing past or historical data and installing software to capture new purchase data in real-time or near real-time.

FIG. 7 depicts a screenshot of an exemplary user interface for prompting the user to import purchase history data associated with a personal digital wardrobe according to an embodiment of the subject matter described herein. Referring to FIG. 7, as a new user, the user may be prompted with a pop-up box: “Ready to Digitize Your wardrobe?” the user may begin the digitization process by clicking “Let's Begin.” After beginning, the system may automatically redirect the user to an email login associated with the email address provided during account creation. The user may then approve access to their email, and the systems and methods described herein may be configured to automatically returns to the website, e.g., Outset.com. In contrast, an email scraper begins capturing data from email receipts over the last two years (a configurable default value), during which a loading message may appear on the screen.

Captured receipt categories may be limited to apparel, shoe, and handbag retailers/brands, but it is appreciated that some embodiments may expand into other categories and industries. Thus, the email scraper captures, for example, brand, retailer, size purchased, product name, product photo(s), price, price paid, color purchased, description, order number, purchase date, and item Stock Keeping Unit (SKU) information from the electronic receipts in their email. As mentioned previously, it is appreciated that some or all of this information may exist only temporarily online. For example, once a retailer no longer sells a garment, the online data associated with that product may be removed and, therefore, later unobtainable by the user.

As discussed in greater detail below, this transaction information obtained from receipts may be enriched (after being aggregated and normalized into a standard format and stored in a database) with additional data. In other words, it may create an enriched digital listing by simultaneously capturing both data from the email receipt and the product's webpage on the website. One embodiment may use “identifiers” on the email receipt to find the product on the retailer's website and capture information on the product's webpage that was not part of the transaction information on the receipt. This additional information may include, for example, product description, product details, measurements, care instructions, additional photos, product category, product subcategory, and product SKU.

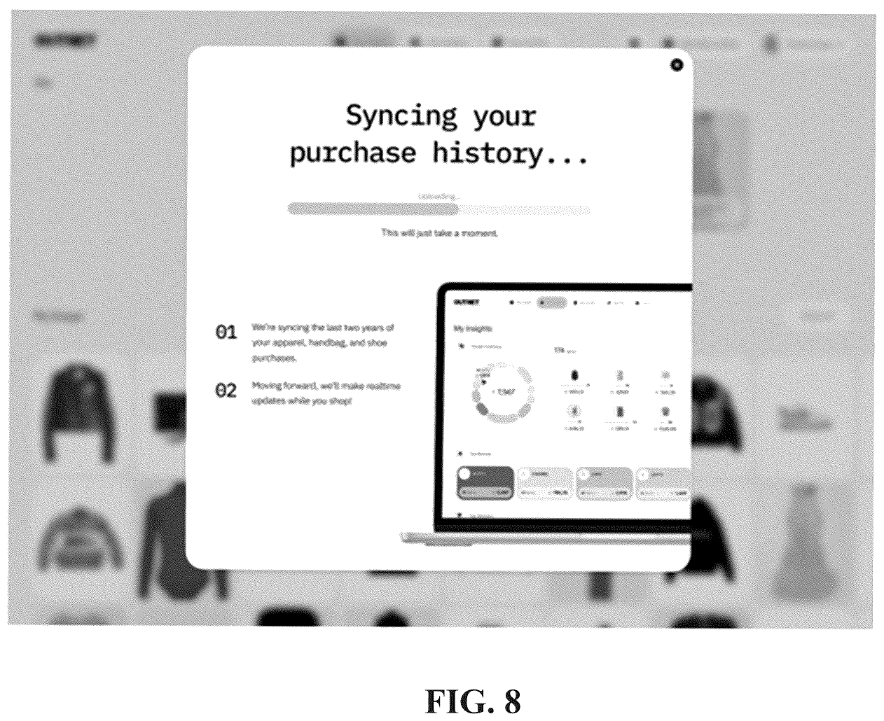

FIG. 8 depicts a screenshot of an exemplary personal digital wardrobe user interface while data may be collected according to an embodiment of the subject matter described herein. Referring to FIG. 8, the user's digital wardrobe may be initially empty while the email scraper collects their historical transaction data. This may be indicated in the lower right portion of the screen, which shows the “We're working on it” progress bar message.

FIG. 9 depicts a screenshot of an exemplary user interface of a user's email account showing an electronic receipt of a purchased item managed by the personal digital wardrobe according to an embodiment of the subject matter described herein. Referring to FIG. 8, an electronic receipt in the user's email shows a purchase of two items: a dress and a top. These items are purchased with an order number, size, color, quantity, price, and photo.

FIG. 10 depicts a screenshot of an exemplary user interface on a third-party website of a product or item to be imported and managed with the personal digital wardrobe according to an embodiment of the subject matter described herein. Referring to FIG. 10, the product page on the third-party website from which the user purchased the item (e.g., silk top) matching their receipt may contain additional information not found on the receipt. For example, the product page for the item indicates “adjustable shoulder ties,” “center back zipper,” “hip length,” side rouching, “slim fitting,” and so on. This additional information may be pulled into and integrated with the user's digital listing on a website, e.g., Outset.com for this item in their digital closet.

Additionally, it may be appreciated that the email scraper may exclude certain types of products listed on an email receipt to avoid inputting products the user does not wish to manage with their digital closet. For example, assume the user's email inbox includes an email receipt from Bloomingdales that includes three dresses and a candlestick. The user may only wish to manage the dresses in their digital closet, so the candlestick information from the shared receipt may not be captured and uploaded to their profile.

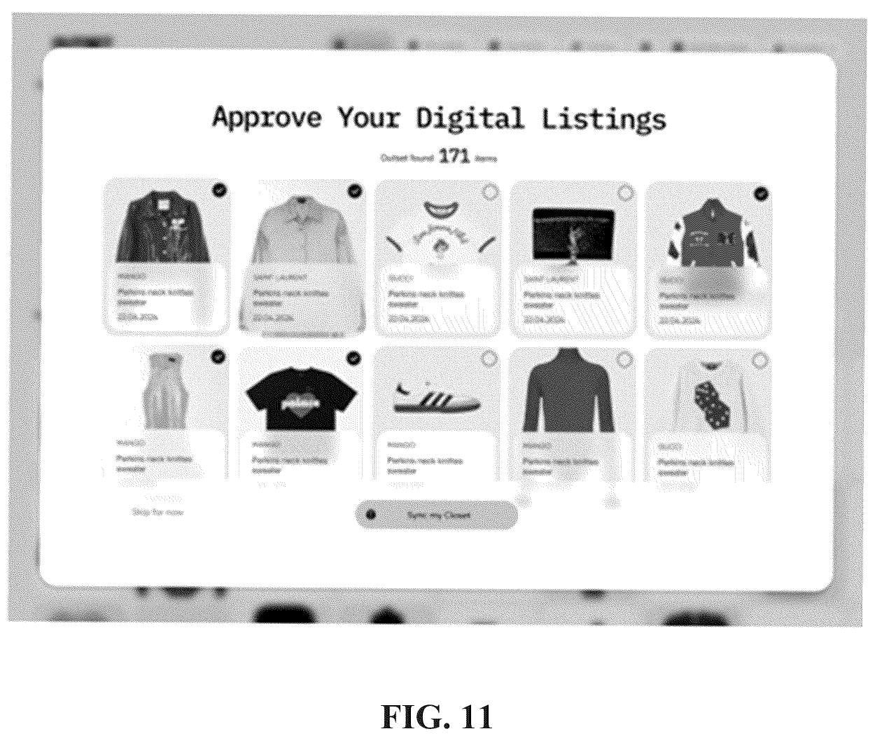

FIG. 11 depicts a screenshot of an exemplary user interface for user approval of digital listings for items in the personal digital wardrobe according to an embodiment of the subject matter described herein. Referring to FIG. 11, after the email scraper has collected transaction and/or additional product information for one or more items obtained from one or more receipts from one or more email accounts and one or more third-party resources, all of the items may be presented in a grid so that the user can manually approve or disapprove of including them in their digital closet. An item or product uploaded and managed by a website, e.g., Outset.com may be called “synchronized.” Here, the user may select each item they wish to sync.

As mentioned previously, it is appreciated that there are multiple ways to capture ongoing customer purchasing data. In one embodiment, an email scraper captures historical purchase data from email receipts and ongoing purchasing data as new receipts are received. In another embodiment, a browser software installed on the user's web browser, such as a browser extension, captures and extracts data from websites and transmits the data to a platform of an embodiment. The customer manually forwards receipts to an email inbox of the systems and methods described herein, in another embodiment. In another embodiment, the customer takes a photo of the receipt and manually uploads it to the an embodiment's platform.

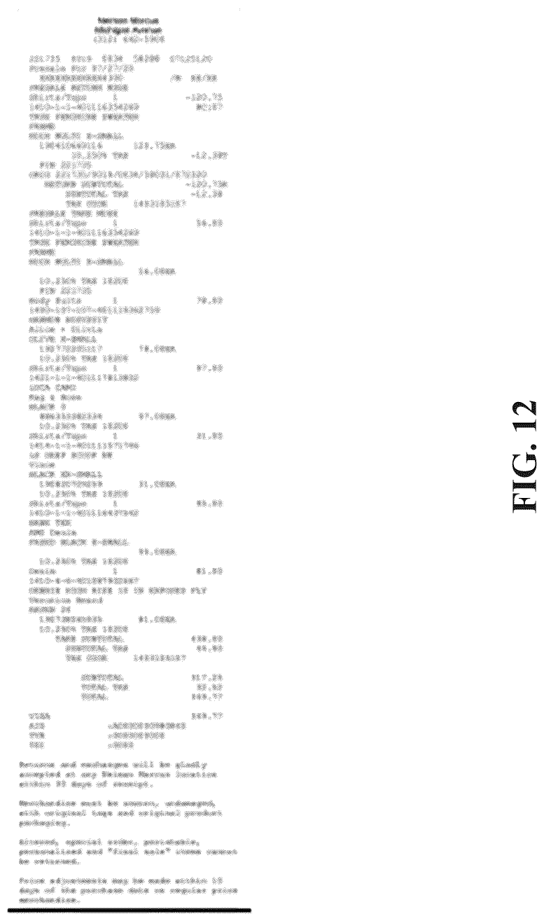

Additionally, it is appreciated that emailed receipts from in-store purchases may differ from email receipts from online purchases, even for purchases of the same item from the same retailer. For example, emailed receipts from in-store purchases may be less descriptive for some retailers. An example of an emailed receipt from an in-store purchase is illustrated in FIG. 12.

FIG. 12 depicts a captured image of a physical receipt of a purchased item that can be uploaded and managed within the personal digital wardrobe according to an embodiment of the subject matter described herein. Referring to FIG. 12, various shorthand codes may describe the products purchased. Compared to some electronic receipts, this receipt from Neiman Marcus does not include product photos or descriptions. The methods and systems described herein may perform optical character recognition (OCR) on the uploaded image of the receipt and then further parse the recognized text within the receipt to identify relevant purchase information, such as brand, retailer, purchase date, item purchase, size, and the like. Text analysis may be performed to identify the relevant information contained in the physical receipt.

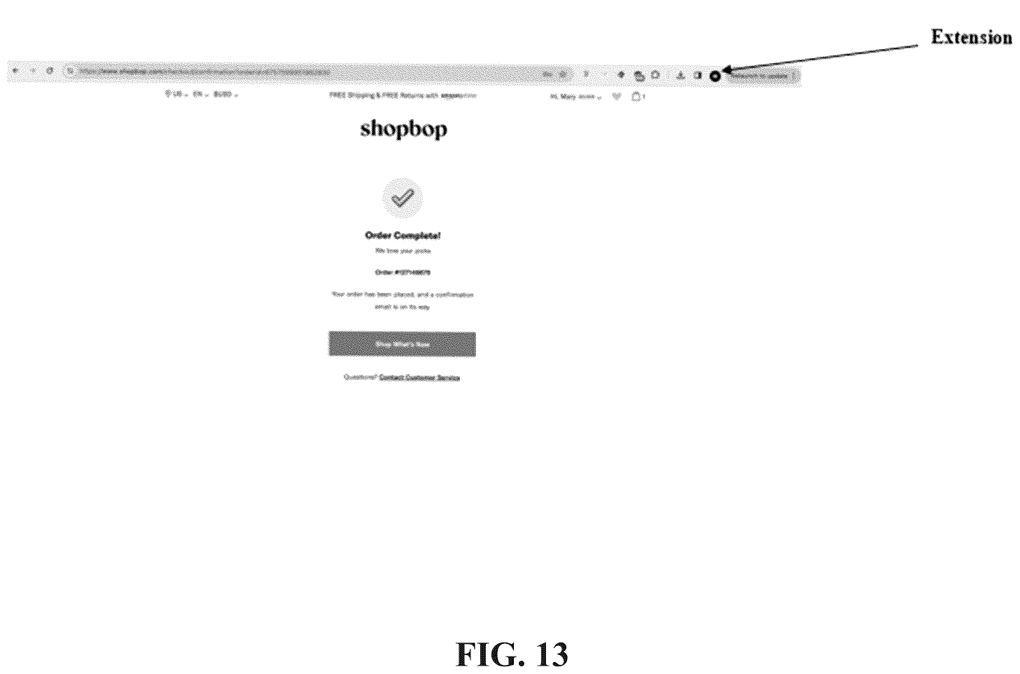

FIG. 13 depicts a screenshot of an exemplary user interface of the browser software that prompts the user to sync purchase data with their digital wardrobe according to an embodiment of the subject matter described herein. Referring to FIG. 13, the user installs a browser software that captures and extracts data from multiple web pages of the website(s) and then transmits the data to the platform.

In an online shopping scenario, when the user “checks out” after purchasing an item and reaches the order confirmation page on an e-commerce retail site (Shopbop), the browser software extracts data from various web pages, including the confirmation page and the product page, to obtain product and checkout details, such as the order number and product title. The product title may be then parsed to determine an apparel category, such as whether the item may be a top, a pair of pants, and other similar elements. The browser software transmits the data to the database. Once integrated into the user's digital closet, the platform's back-end and front-end servers may service queries for data from the database.

For example, the user goes to bloomingdales.com and buys three dresses. The user checks out and gets to the order confirmation page. The purchase triggers the browser software to capture purchase data during purchase/checkout. The software captures data on multiple web pages of the bloomingdales.com website, including the confirmation page, the checkout page, and the product listing page. The user receives a notification from the software that allows the user to sync their listings. The user can turn notifications to silent, and the browser software automatically transmits the data to the virtual wardrobe. The browser software transmits the data to the database. For each product, the browser software captures, for example, the retailer, photos, order confirmation, date of purchase, purchase price, original price, product name, product brand, product description, pictures, color purchased, product category, product subcategory, size purchased, measurements, materials, and the like.

In an in-store shopping scenario, the user buys three dresses at the Bloomingdale store in New York City. The user pays, and Bloomingdales sends the user a receipt confirmation. In near real-time (e.g., when the receipt is received in the user's email inbox), the browser software may be triggered and recognizes that the user has received a receipt from Bloomingdales. The browser software transmits the data to the database. The browser software may capture the same details for each item for the online receipt listed above. The browser software pulls data from the website's product page for each item, including more photos, item descriptions, materials, categories, and product subcategories.

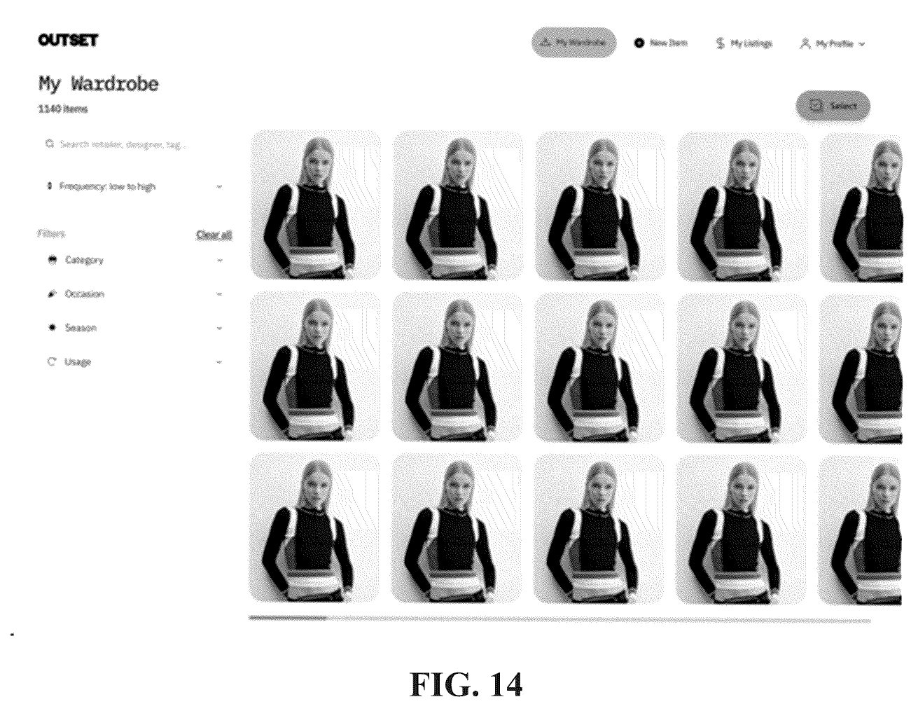

FIG. 14 depicts a screenshot of an exemplary personal digital wardrobe user interface according to an embodiment of the subject matter described herein. Referring to FIG. 14, users see all their clothing on the “My Closet” page. The user sees their “Top Brands” based on items purchased. They can filter through the clothes by designer, color, and category.

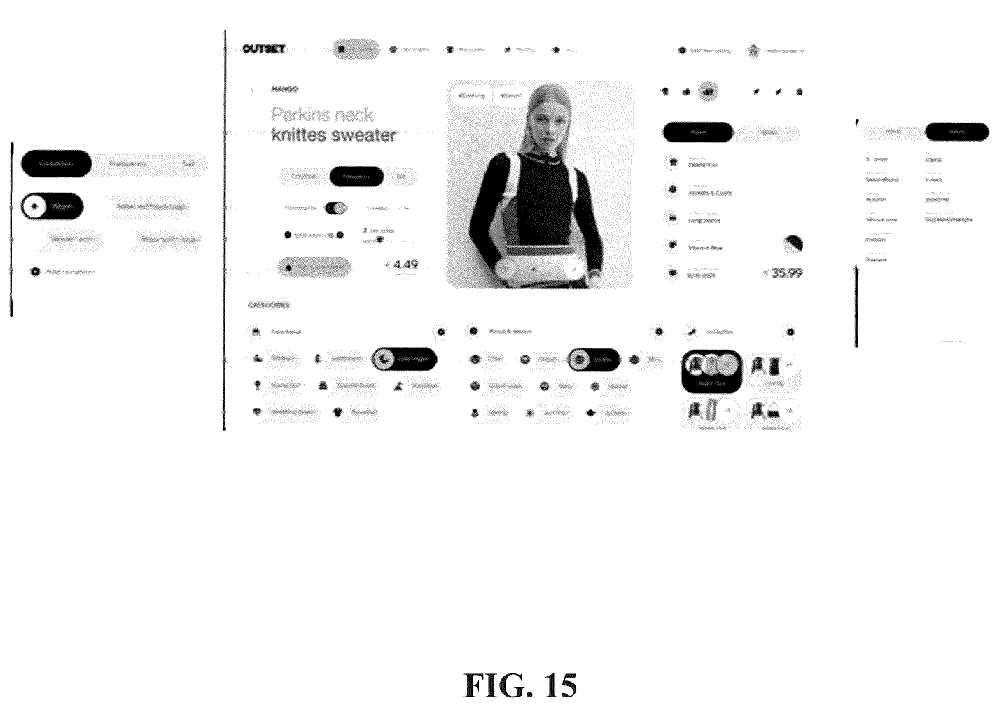

The user can filter or sort by oldest item to newest item in the closet, frequency of wear, and most liked to least liked. The user can also click on the piece of clothing, which may take them to the “digital listing detail page” illustrated in FIG. 15.

FIG. 15 depicts a screenshot of an exemplary personal digital wardrobe user interface according to an embodiment of the subject matter described herein. Referring to FIG. 15, the digital listing detail page includes enriched product information. The user can interact with (i.e., manage) their garment on the digital listing detail page. For example, the user can rank how much they like each item (e.g., “Love,” “Like,” “It's just all right”) and rank how much they wear it (e.g., “low, medium, high”). The user can view the garment based on the time it takes to be in the closet. Additional UX/UI features may include, for example, automated cost-per-wear tracking, scanning the user's camera roll to identify each time an item was worn, and liking/disliking a garment using thumbs up/thumbs down icons.

FIG. 16 depicts a screenshot of an exemplary personal digital wardrobe user interface according to an embodiment of the subject matter described herein. The system described herein may transform the digital listings into personalized insights that provide the user with a more customized and personalized experience in the future for making better informed future purchasing decisions that build and bridge the gaps in the existing digital inventory listings.

Referring to FIG. 16, the “My insights” page provides both shopping data and closet data based on the user's purchase(s). For example, the user can see the top brands they are buying, which retailer they spend the most on, and a breakdown of categories in their closet (e.g., number of tops, dresses, pants, and other similar elements). They can also see a data overview displaying, for example, likeability and frequency-of-wear statistics, as illustrated in the pie chart on the right side of FIG. 16.

In other embodiments, the user's digital closet may capture and display resale value data of the products the user purchased and has synced to their digital wardrobe based on real-time or close to real-time data. For example, live pricing data of handbags, apparel, and other similar elements may be determined based on pricing data obtained from a retail website. By obtaining and displaying live pricing information for their digital closet, the user may be informed of the total value of their wardrobe in real-time. Similarly, the live pricing may include data pulled from third-party resellers' websites to provide the user with a current market value of their digital wardrobe or a specific article or product within their wardrobe. Knowing such information helps the user decide whether and/or when to list a particular product on a third-party reseller's website.

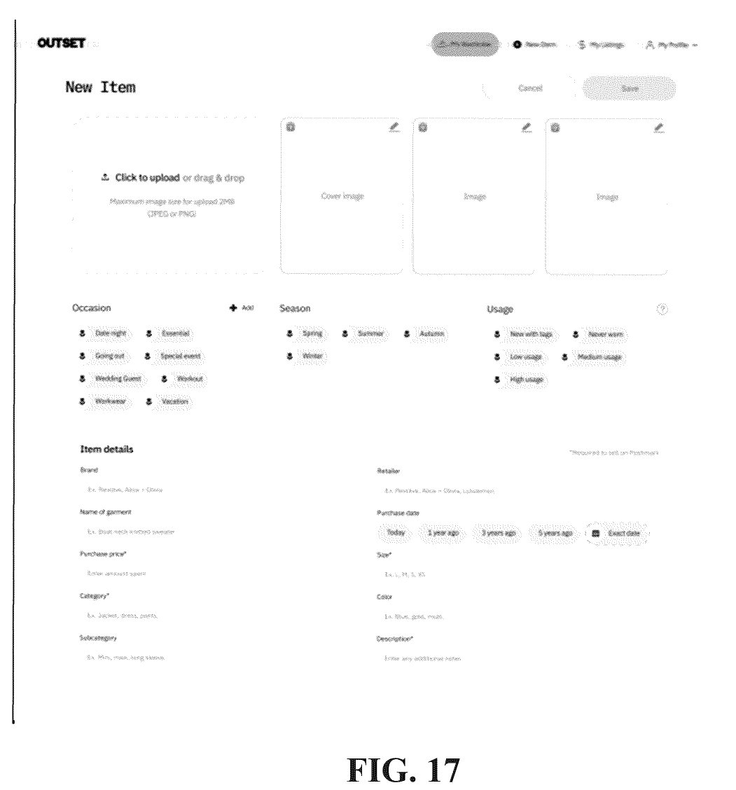

FIG. 17 depicts a screenshot of an exemplary user interface for manually uploading an item to the user's digital wardrobe according to an embodiment of the subject matter described herein. Referring to FIG. 17, the user can upload data and images associated with an item to be managed via their digital closet using a form containing a plurality of input fields.

Once the user has added items to their digital closet, whether via the email scraper automatically obtaining data from electronic receipts of past purchases, via a browser software automatically obtaining data at checkout of the item purchase, or manually via an input form on a website, e.g., Outset.com, the user can use their digital closet for a variety of new uses by sending a signal from a platform to a third-party website.

One such new use made possible by the signal transmitted from the platform may automatically cross-list an item for sale to one or more third-party websites. By leveraging the data and single interface of their digital possession portfolio, the user can avoid the burden of manually entering and uploading information to each of a plurality of resale websites for the same item. Some embodiments may accomplish this one-click feature by integrating with multiple third-party resale websites, whether via an API or other means, for translating the data and formatting requirements of the third-party resale websites with the aggregated, normalized, and enriched data contained in an example database.

Managing and tracking personal digital inventory, particularly for resale purposes, is challenging due to the disparate sources of product information, inconsistent data formats, and the manual effort required to list items for sale on multiple third-party platforms. Consumers often struggle to efficiently aggregate, organize, and utilize their purchase data for inventory management, resale, and analytics. In an example embodiment, the systems and methods described herein may addresses this problem by providing an automated and integrated platform for capturing, normalizing, enriching, and managing digital inventory listings. Features of some example embodiments may include, but are not limited to (1) Data Aggregation and Normalization: The system automatically captures purchase data from various sources, such as email receipts and retailer websites, and normalizes this data into a consistent format for easy management and analysis, (2) Data Enrichment: The system enhances digital inventory listings with additional details, such as product descriptions and images, by extracting information from multiple web pages and databases. (3) Automated Cross-Listing: The system enables automatic cross-listing of products on multiple third-party resale sites, adapting the digital inventory listings to meet the specific requirements of different platforms, thereby reducing manual effort and increasing efficiency, (4) Analytics and Insights: The system provides users with analytics and insights derived from their digital inventory, such as spending trends and resale value estimates, enabling informed decision-making, and (5) Machine Learning Algorithms: The system employs machine learning algorithms to improve data enrichment, category mapping, and other functionalities, enhancing the accuracy and efficiency of the platform. Thus, the systems, methods, and devices described herein may provide a comprehensive and automated approach to managing personal digital inventory for resale and analytics, addressing the challenges associated with data aggregation, organization, and utilization.

In an example embodiment, capturing transaction information for a purchase of an item associated with a user involves several substeps. The system may employ an email scraper that automatically connects to the user's email server to search for digital receipts. Upon detecting a receipt, the system extracts relevant data such as the item's name, purchase date, price, and retailer. Alternatively, for online purchases, a browser extension may monitor the user's transactions in real-time or near real-time, capturing transaction details as the purchase is completed. This captured information forms the basis for further processing and integration into the digital inventory system.

In an example embodiment, the system aggregates item information from multiple sources to create a comprehensive dataset for each purchased item. This process involves accessing various websites, webpages, and databases through APIs to gather additional details such as product descriptions, images, and specifications. The system may also incorporate user-provided information to enhance the accuracy and completeness of the aggregated data. This aggregation step ensures that the digital inventory contains a rich set of information for each item.

In an example embodiment, normalizing the captured transaction information and the aggregated item information involves standardizing data formats and resolving inconsistencies across different sources. The system may apply predefined rules to convert various date formats to a standard format, unify currency representations, and reconcile differences in product naming conventions. This normalization process facilitates the integration of data from diverse sources into a coherent digital inventory.

In an example embodiment, enriching the transaction information or the item information entails obtaining additional information associated with the item or the transaction from multiple different sources. The system may access external databases to retrieve historical pricing data, user reviews, and product ratings. It may also analyze social media platforms to gather user-generated content related to the item. This enrichment step adds depth to the digital inventory, providing users with a more detailed understanding of their purchases.

In an example embodiment, generating a digital inventory based on enriched data involves organizing and structuring the enriched data to create a comprehensive listing of the user's items. The system may categorize items based on type, brand, or purchase date, and provide filtering and sorting options to facilitate easy navigation. Each item's listing in the digital inventory includes detailed information derived from the aggregation and enrichment steps, offering a complete overview of the user's possessions.

In an example embodiment, providing a user interface for viewing and managing the digital inventory involves offering a visually intuitive and interactive platform for users to engage with their digital inventory. The user interface may include features such as a dashboard overview of recent purchases, detailed item pages with all relevant information, and tools for editing or deleting items. Users can also utilize the interface to perform actions such as cross-listing items for sale on third-party websites, thereby leveraging the digital inventory for practical purposes.

As may be appreciated by one skilled in the art, aspects of the technology described herein may be embodied as a system, method, or computer program product. Accordingly, aspects of the technology may take the form of an entire hardware embodiment, an entire software embodiment (including firmware, resident software, micro-code, and other similar elements), or an embodiment combining software and hardware aspects that may all generally be referred to herein as a “circuit,” “module” or “system.” Furthermore, aspects of the technology may take the form of a computer program product embodied in one or more computer-readable medium(s) with computer-readable program code embodied thereon.

Any combination of one or more computer-readable medium(s) may be utilized. The computer-readable medium may be a computer-readable signal medium or a computer-readable storage medium (including, but not limited to, non-transitory computer-readable storage media). A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM) or Flash memory, an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in a baseband or as part of a carrier wave. Such a propagated signal may take various forms, including, but not limited to, electromagnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, Radio Frequency (RF), and other similar elements, or any suitable combination of the foregoing.

Computer program code for carrying out operations for aspects of the technology described herein may be written in any combination of one or more programming languages, including object-oriented and/or procedural programming languages. Programming languages may include but are not limited to Ruby®, JavaScript®, Java®, Python®, PHP, C, C++, C#, Objective-C®, Go®, Scala®, Swift®, Katlin®, OCaml®, or the like. The program code may execute entirely on the user's computer, partly on the user's computer, as a stand-alone software package, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the technology described herein refer to flowchart illustrations and/or block diagrams of methods, apparatus (systems) and computer program products according to various embodiments. It will be understood that each block of the flowchart illustrations and/or block diagrams and combinations of blocks in the flowchart illustrations and/or block diagrams can be implemented using computer program instructions.

These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture, including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the technology described herein. In this regard, each block in the flowchart or block diagrams may represent a module, segment, or portion of code comprising one or more executable instructions for implementing the specified logical function(s). It should also be noted that in some alternative implementations, the functions noted in the block may occur out of order, as noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a,” “an” and “the” are intended to include the plural forms as well, unless the context clearly indicates otherwise. Thus, for example, reference to “a user” can include a plurality of such users, and so forth. It may be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description provided herein has been presented for illustration and description but is not intended to be exhaustive or limited to the specific form disclosed. Many modifications and variations will be apparent to those of ordinary skill in the art without departing from the scope and spirit of the disclosure. The embodiment was chosen and described to best explain the principles described herein and the practical application of those principles and to enable others of ordinary skill in the art to understand the technology for various embodiments with various modifications suited to the particular use contemplated.

The descriptions of the various embodiments of the technology disclosed herein have been presented for purposes of illustration, but these descriptions are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The preceding disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code it is understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like) and may be used interchangeably with “one or more.” The phrase “only one” or similar language is used where only one item is intended. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or” unless explicitly stated otherwise (e.g., if used in combination with “either” or “only one of”).

One or more elements or aspects or steps, or any portion(s) thereof, from one or more of any of the systems and methods described herein, may be combined with one or more elements or aspects or steps, or any portion(s) thereof, from one or more of any of the other systems and methods described herein and combinations thereof, to form one or more additional implementations and/or claims of the present disclosure.

One or more components, steps, features, and/or functions illustrated in the figures may be rearranged and/or combined into a single component, block, feature, or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily refer to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this Application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects illustrated herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A computer-implemented method for providing digital inventory management, the method comprising:
capturing transaction information for a purchase of an item associated with a user; aggregating item information from multiple sources, wherein at least one of the multiple sources is accessed using a connection through an API; normalizing the captured transaction information and the aggregated item information;
enriching the transaction information or the item information by obtaining additional information associated with the item or the transaction from multiple different sources;
generating a digital inventory based on enriched data, wherein the digital inventory includes a listing of the item based on the enriched data; and
providing a user interface for viewing and managing the digital inventory.

2. The computer-implemented method of claim 1, wherein the transaction information is captured using an email scraper via an electronic connection to an email server associated with the user.

3. The computer-implemented method of claim 1, wherein the transaction information is captured during an online purchase using a browser extension configured to monitor the online purchase in real-time or near real-time.

4. (canceled)

5. The computer-implemented method of claim 1, wherein the multiple sources include websites, webpages, databases, and the user.

6. The computer-implemented method of claim 1, wherein the transaction information is obtained in real-time or near real-time.

7. The computer-implemented method of claim 1, wherein capturing the transaction information in real-time or near real-time uses a web browser software to monitor the transaction.

8. The computer-implemented method of claim 1, wherein the captured transaction information is historical transaction information associated with a past purchase transaction, and wherein capturing historical transaction information associated with a past purchase transaction includes automatically searching and analyzing one or more email accounts associated with the user for digital receipts associated with one or more transactions.

9. (canceled)

10. The computer-implemented method of claim 1, further comprising storing at least one of the captured transaction information, the aggregated item information, the normalized information, and the enriched information in a database.

11. The computer-implemented method of claim 1, further comprising automatically cross-listing the item to multiple third-party websites, from within the user interface provided for viewing and managing the digital inventory, based on at least one of the captured transaction information, the aggregated item information, the normalized information, and the enriched information, wherein the automatic cross-listings are generated using an APL.

12. (canceled)

13. (canceled)

14. A system for providing digital inventory management via Software as a service (SaaS), the system comprising:
a computer communicatively coupled to a network, at least one SaaS provider, and at least one SaaS user, and wherein the computer is configured for:
capturing transaction information for a purchase of an item associated with a user;
aggregating item information from multiple sources, wherein at least one of the multiple sources is accessed using a connection through an API;
normalizing the captured transaction information and the aggregated information;
enriching the transaction information or the item information by obtaining additional information associated with the item or the transaction;
generating a digital inventory based on enriched data, wherein the digital inventory includes a listing of the item based on the enriched data; and
providing a user interface for viewing and managing the digital inventory.

15. (canceled)

16. A computing system configured to transform and assemble data from third-party web pages across multiple websites into customized digital inventory listings for multi-purpose use, the computing system compromising:
browser software installed on a user device, wherein the browser software is configured to:
recognize a user's purchasing activity on the browser;
automatically capture, based on the user's purchasing activity, specific product and purchasing details from multiple web-based sources; and
store the specific product and purchasing details in a system database; wherein the system database is configured to:
receive and assemble the specific product and purchasing details from the multiple web-based sources into a single digital inventory listing, wherein the single digital inventory listing is customized for the user;
catalog the single digital inventory listing including presenting the single digital inventory listing to the user via a graphical user interface; and
alter the graphical interface based on receiving user input or new purchase activity; and invoke a function of use on a third-party website to automatically cross-list a product from the single digital inventory listing based on the specific product and purchasing details from multiple web-based sources and user-provided information.

17. The computing system of claim 16, wherein the user's purchase on a checkout web page is authenticated, approved, settled by a bank and credit card network and a merchant receives credit.

18. The computing system of claim 17, wherein a confirmation of purchase is identified by examining a HyperText Markup Language content on a checkout webpage and purchase confirmation webpage.

19. (canceled)

20. (canceled)

21. The computing system of claim 16, wherein the digital inventory listing is linked or shared to a third-party social-media platform and wherein a server database automatically links or shares the digital listing to the third-party social-media platform based on user instructions.

22. The computing system of claim 16, wherein the browser software is configured to generate a visual display box on a purchase confirmation web page illustrating details of information captured and allowing the user to view all of captured data in more detail or command the browser software to transmit the data.

23. (canceled)

24. The computing system of claim 16, wherein the browser software is implemented for installation on a mobile device.

25. The computing system of claim 16, wherein browser software captures data from multiple web pages of multiple websites including: the product listing page specific to the user's purchase, a checkout cart web page, a checkout web page, a confirmation of purchase web page, a user's historical browser webpage, and webpages of other browsers that the user receives digital purchasing data including a user's email.

26. (canceled)

27. (canceled)

28. The computing system of claim 16, wherein a catalog of customized, digital inventory listings is viewable to the user and there exists an ability to filter, search, prioritize and interact with digital inventory listings.

29. The computing system of claim 16, wherein Interacting with individual digital inventory listings is available in a way that allows the user to rank, score, and comment on the listing to further categorize and call out the listing.

30. The computing system of claim 16, wherein, upon receiving transmitted data from the browser software, the system database automatically performs the following steps:
aggregate the data pulled from the browser software which sourced from multiple web pages of websites;
apply internal data specific to the purchaser; alter a graphical and visual display; and
modify content to create a digital inventory listing personalized to an individual user,
wherein, upon user selection, the database automatically transmits the listing to multiple different websites and databases for new functionality specific to the individual user's needs.
